(19) United States
(12) Patent Application Publication
(10) Pub. No.: US 2026/0217118 A1
(43) Pub. Date: Jul. 30, 2026

(54) Dynamic Image Generation for Vehicle Displays

(71) Applicant: Nissan North America, Inc., Franklin, TN (US)

(72) Inventors: Mark Bailey, Seattle, WA (US); Corey Heath, Scottsdale, AZ (US)

(21) Appl. No.: 19/039,047

(22) Filed: Jan. 28, 2025

(51) Int. Cl. B60K 35/28; B60K 35/10; B60K 35/65

(52) U.S. Cl. CPC B60K 35/28; B60K 35/10; B60K 35/654; B60K 2360/1868; B60K 2360/31; B60K 2360/731; B60K 2360/741

(57) ABSTRACT

Current data related to at least one of an operation of a vehicle or an environment outside of the vehicle is obtained. A difference between the current data and historical data is determined, where the difference comprises at least one of a change in an operation of the vehicle or a change in the environment. Dynamic image data is generated based on a visualization style and the difference. The dynamic image data is output to cause a display device associated with the vehicle to display dynamic image content corresponding to the dynamic image data.

### TECHNICAL FIELD

The present disclosure relates to vehicle display systems, and more particularly to a dynamic image generation system for vehicle displays.

### BACKGROUND

Modern vehicles are becoming increasingly sophisticated, with advanced digital displays and infotainment systems providing drivers with a wealth of information. These displays often present static or pre-programmed content that may not fully capture the dynamic nature of driving or effectively convey critical information to the driver. As vehicles, particularly electric vehicles, become quieter and more isolated from external stimuli, drivers may find it challenging to maintain awareness of their vehicle's status and surrounding environment. There is a growing need for more intuitive and engaging ways to present vehicle information that can adapt to changing driving conditions and enhance driver awareness without causing distraction.

### SUMMARY

In one embodiment, a dynamic image generation system for a vehicle display is provided. In this embodiment, the dynamic image generation system includes one or more sensors configured to obtain current data related to at least one of an operation of the vehicle or an environment outside of the vehicle, a display device, a memory having instructions stored therein, and processing circuitry communicatively coupled to the one or more sensors, the display device, and the memory. The processing circuitry is configured to execute the instructions to cause the dynamic image generation system to determine a difference between the current data and historical data, the difference comprising at least one of a change in an operation of the vehicle or a change in an interaction between the vehicle and the environment, generate dynamic image data based on a visualization style and the difference, and output the dynamic image data to cause the display device to display dynamic image content corresponding to the dynamic image data.

In another embodiment, a method for generating dynamic image content for a display system of a vehicle is provided. In this embodiment, the method includes obtaining current data related to at least one of an operation of the vehicle or an environment outside of the vehicle, determining a difference between the current data and historical data, the difference comprising at least one of a change in an operation of the vehicle or a change in the environment, generating dynamic image data based on a visualization style and the difference, and outputting the dynamic image data to cause a display device associated with the vehicle to display dynamic image content corresponding to the dynamic image data.

In yet another embodiment, a non-transitory computer-readable storage medium storing a set of instructions is provided. In this embodiment, when executed by processing circuitry of a device, the instructions cause the device to perform operations comprising obtaining current data related to at least one of an operation of a vehicle or an environment outside of the vehicle, determining a difference between the current data and historical data, the difference comprising at least one of a change in an operation of the vehicle or a change in the environment, generating dynamic image data based on a visualization style and the difference, and outputting the dynamic image data to cause a display device associated with the vehicle to display dynamic image content corresponding to the dynamic image data.

These and other aspects, features, elements, implementations, and embodiments of the methods, apparatus, procedures, and algorithms disclosed herein are described in further detail hereafter.

### BRIEF DESCRIPTION OF THE DRAWINGS

The disclosed technology is best understood from the following detailed description when read in conjunction with the accompanying drawings. It is emphasized that, according to common practice, the various features of the drawings may not be to scale. For example, the dimensions of various features may be expanded or reduced for clarity. Further, like reference numbers refer to like elements throughout the drawings unless otherwise noted.

FIG. 1 is a diagram of an example of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 shows a block diagram of an example of a computing device capable of performing functions described later herein.

FIG. 4 illustrates an example of a portion of an interior of a vehicle, in accordance with the present disclosure.

FIG. 5 is a diagram of an operating environment including an in-vehicle infotainment system, in accordance with embodiments of this disclosure.

FIG. 6 is a block schematic diagram illustrating an example associated with dynamic image generation, in accordance with the present disclosure.

FIG. 7 is a flow diagram illustrating another example associated with dynamic image generation, in accordance with the present disclosure.

FIGS. 8A-8C are diagrams illustrating examples associated with dynamic image generation, in accordance with the present disclosure.

FIG. 9 is a flow diagram illustrating an example of a technique associated with dynamic image generation, in accordance with the present disclosure.

### DETAILED DESCRIPTION

In modern vehicles, advanced digital displays and infotainment systems are becoming increasingly prevalent, providing drivers with a wealth of information about their vehicle's status and surroundings. However, these systems often present static or pre-programmed content that may not fully capture the dynamic nature of driving or effectively convey information to the driver. As vehicles, particularly electric vehicles, become quieter and more isolated from external stimuli, drivers may find it challenging to maintain awareness of their vehicle's status and the surrounding environment. This technological challenge is further compounded by the limitations of human cognitive capacities to process and interpret large amounts of visual information while operating a vehicle.

Current vehicle display systems typically rely on fixed graphical representations or pre-defined animations to convey information. These static approaches often fail to adapt to rapidly changing driving conditions, environmental factors, or individual driver preferences. The lack of real-time, context-aware visual feedback can lead to information overload or, conversely, a lack of information when it is most needed. Additionally, the increasing complexity of modern vehicles, with their numerous sensors and advanced driver assistance systems, generates vast amounts of data that are not effectively utilized in current display paradigms.

The disconnect between the rich, dynamic data available from vehicle sensors and the static nature of current display systems creates a technological hurdle in providing drivers with intuitive and engaging visual information. This problem is particularly acute in situations where rapid changes in vehicle status or environmental conditions require immediate driver attention. The inability of current systems to prioritize and present information based on real-time context and driver behavior patterns can lead to delayed reactions, reduced situational awareness, and potentially compromised safety.

Furthermore, the phenomenon known as “banner blindness,” where drivers become desensitized to repetitive visual information, poses an additional challenge for existing display technologies. As drivers become accustomed to static or predictable visual cues, they may overlook important information, especially during long periods of driving. This technological limitation undermines the effectiveness of vehicle displays as an interface between the complex systems of modern vehicles and their human operators, highlighting the need for more dynamic and adaptive visual communication systems in automotive applications.

Implementations of this disclosure address problems such as these by providing a dynamic image generation system for vehicle displays that adapts visual content based on real-time data from the vehicle and its environment. The system includes one or more sensors configured to obtain current data related to at least one of an operation of the vehicle or an environment outside of the vehicle, a display device, a memory having instructions stored therein, and processing circuitry communicatively coupled to the sensors, display device, and memory. The processing circuitry is configured to execute instructions to determine a difference between the current data and historical data, generate dynamic image data based on a visualization style and the difference, and output the dynamic image data to cause the display device to display dynamic image content corresponding to the dynamic image data.

In some implementations, the current data may comprise at least one of a speed of the vehicle, an acceleration of the vehicle, a weather condition, or an interaction between the vehicle and a road. The term “current data” refers to real-time or near-real-time information collected by the vehicle's sensors. For example, current data may include the vehicle's current speed as measured by a speedometer, the current rainfall intensity detected by rain sensors, or the lateral forces experienced by the vehicle when cornering. In some implementations, additional types of current data may include traffic conditions, driver biometrics, or vehicle system status.

The one or more sensors used in the system may comprise at least one of a radar device, a light detection and ranging (LiDAR) device, a camera device, a proximity sensor, a vehicle control device that controls an aspect of the operation of the vehicle, a weather monitoring device, a motion sensor, an inertial measurement unit (IMU), or a geo-location device. These sensors work together to provide a comprehensive understanding of the vehicle's operation and its surrounding environment. For instance, a LIDAR device may be used to create a 3D map of the vehicle's surroundings, while an IMU may provide data on the vehicle's acceleration and orientation. In some implementations, the system may also incorporate data from external sources, such as weather forecasts or traffic updates.

The display device in the system may comprise at least one of a windshield of the vehicle, a head-up display (HUD) device of the vehicle, an instrument cluster of the vehicle, an infotainment system of the vehicle, or an electronic device of a user of the vehicle. The term “display device” encompasses any visual output mechanism capable of presenting the dynamic image content to the vehicle occupants. For example, a HUD may project information directly onto the windshield, while an instrument cluster may use digital screens to replace traditional analog gauges. In some implementations, augmented reality displays may be integrated into side windows or rear-view mirrors, or haptic feedback systems may complement the visual displays.

In some implementations, to determine the difference between the current data and the historical data, the processing circuitry may determine a first parameter value based on the current data, determine a second parameter value based on the historical data, and determine a difference between the first parameter value and the second parameter value. This process allows the system to identify changes or deviations from typical operating conditions. For instance, if the historical data shows that a driver typically maintains a speed of 65 mph on a particular highway, but the current speed is 80 mph, the system may generate dynamic image content to subtly encourage the driver to reduce speed.

The generation of dynamic image data based on a visualization style and the difference may involve determining a visualization style based on at least one of a set of configured visualization styles or an operating context of the vehicle, obtaining an image corresponding to the visualization style from an image store based on the difference, and generating the dynamic image data based on the visualization style and the image. The term “visualization style” refers to the overall aesthetic and functional approach to presenting information visually. For example, a sporty visualization style might use bold colors and dynamic animations, while a more conservative style might use muted colors and subtle transitions. In some implementations, the system may allow users to customize visualization styles or create their own.

In some implementations, the system may include features such as personalized visualization styles based on driver profiles, integration with external media platforms to incorporate relevant content into the dynamic displays, or adaptive learning algorithms that refine the visualization styles based on driver interactions and preferences over time. The system may also be designed to work in conjunction with advanced driver assistance systems (ADAS) or autonomous driving features, adapting the visual content to support different levels of vehicle autonomy.

By providing real-time, context-aware visual feedback, this dynamic image generation system enhances driver awareness and engagement, potentially improving safety and overall driving experience. The system's ability to adapt to changing conditions and individual preferences represents an advancement over traditional static or pre-programmed vehicle displays, addressing the challenges of information overload and driver distraction in modern vehicles.

In some implementations, the dynamic image generation system determines a difference between current data and historical data related to vehicle operation or the surrounding environment. Accordingly, an advantage of determining this difference is the ability to identify changes or deviations from typical operating conditions in real-time. Additionally, an advantage of determining this difference is the system's capacity to adapt visual content based on evolving driving situations, enhancing driver awareness. Furthermore, an advantage of determining this difference is the potential for early detection of anomalies or potential hazards, which may improve overall vehicle safety.

In some implementations, the dynamic image generation system generates dynamic image data based on a visualization style and the determined difference. Accordingly, an advantage of generating dynamic image data is the creation of visually engaging and context-aware displays that capture the driver's attention more effectively than static content. Additionally, an advantage of generating dynamic image data is the ability to prioritize and emphasize information based on current driving conditions. Moreover, an advantage of generating dynamic image data is the potential for reducing cognitive load on the driver by presenting information in an intuitive and easily digestible format.

In some implementations, the dynamic image generation system incorporates data from multiple sensors, including radar devices, LIDAR devices, camera devices, and various vehicle control and monitoring systems. Accordingly, an advantage of incorporating data from multiple sensors is a more comprehensive understanding of the vehicle's status and its surrounding environment. Additionally, an advantage of incorporating data from multiple sensors is improved accuracy and reliability of the generated dynamic image content. Furthermore, an advantage of incorporating data from multiple sensors is the ability to provide a multi-faceted representation of complex driving scenarios, potentially enhancing the driver's situational awareness.

In some implementations, the dynamic image generation system allows for customization of visualization styles based on user input or driver profiles. Accordingly, an advantage of customizable visualization styles is increased user satisfaction through personalized display preferences. Additionally, an advantage of customizable visualization styles is the ability to cater to different driving styles or experience levels, potentially improving the effectiveness of information delivery for a wide range of users. Moreover, an advantage of customizable visualization styles is the flexibility to adapt the system for various vehicle types or specialized applications, such as performance driving or off-road use.

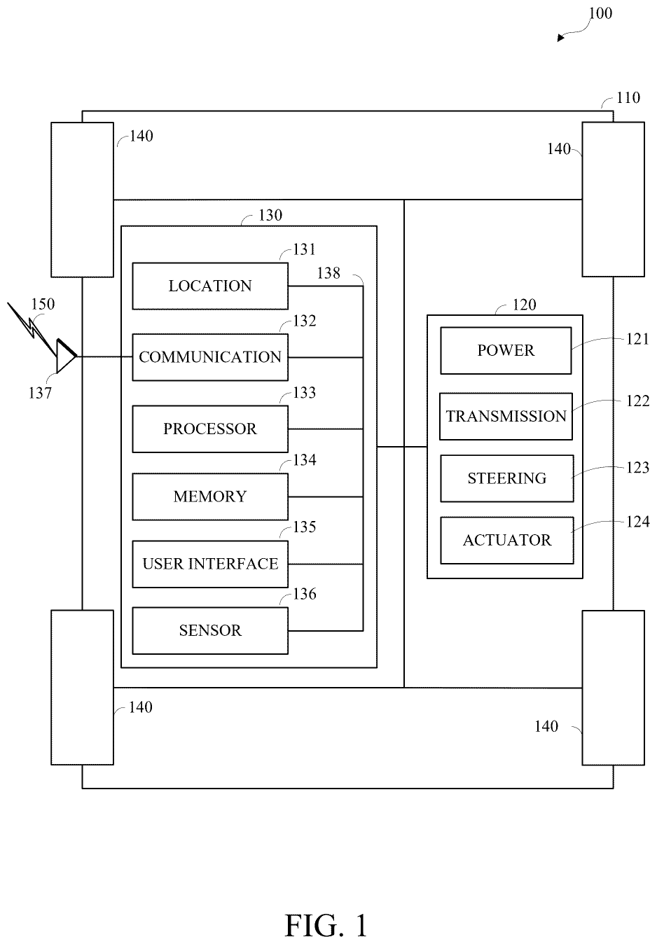

FIG. 1 is a diagram of an example of a vehicle in which the aspects, features, and elements disclosed herein may be implemented. As shown, a vehicle 100 includes a chassis 110, a powertrain 120, a controller 130, and wheels 140. Although the vehicle 100 is shown as including four wheels 140 for simplicity, any other propulsion device or devices, such as a propeller or tread, may be used. In FIG. 1, the lines interconnecting elements, such as the powertrain 120, the controller 130, and the wheels 140, indicate that information, such as data or control signals, power, such as electrical power or torque, or both information and power, may be communicated between the respective elements. For example, the controller 130 may receive power from the powertrain 120 and may communicate with the powertrain 120, the wheels 140, or both, to control the vehicle 100, which may include accelerating, decelerating, steering, or otherwise controlling the vehicle 100.

As shown, the powertrain 120 includes a power source 121, a transmission 122, a steering unit 123, and an actuator 124. Other elements or combinations of elements of a powertrain, such as a suspension, a drive shaft, axles, or an exhaust system may be included. Although shown separately, the wheels 140 may be included in the powertrain 120.

The power source 121 may include an engine, a battery, or a combination thereof. The power source 121 may be any device or combination of devices operative to provide energy, such as electrical energy, thermal energy, or kinetic energy. For example, the power source 121 may include an engine, such as an internal combustion engine, an electric motor, or a combination of an internal combustion engine and an electric motor, and may be operative to provide kinetic energy as a motive force to one or more of the wheels 140. The power source 121 may include a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 122 may receive energy, such as kinetic energy, from the power source 121, and may transmit the energy to the wheels 140 to provide a motive force. The transmission 122 may be controlled by the controller 130 the actuator 124 or both. The steering unit 123 may be controlled by the controller 130 the actuator 124 or both and may control the wheels 140 to steer the vehicle. The actuator 124 may receive signals from the controller 130 and may actuate or control the power source 121, the transmission 122, the steering unit 123, or any combination thereof to operate the vehicle 100.

As shown, the controller 130 may include a location unit 131, an electronic communication unit 132, a processor 133, a memory 134, a user interface 135, a sensor 136, an electronic communication interface 137, or any combination thereof. Although shown as a single unit, any one or more elements of the controller 130 may be integrated into any number of separate physical units. For example, the user interface 135 and the processor 133 may be integrated in a first physical unit and the memory 134 may be integrated in a second physical unit. Although not shown in FIG. 1, the controller 130 may include a power source, such as a battery. Although shown as separate elements, the location unit 131, the electronic communication unit 132, the processor 133, the memory 134, the user interface 135, the sensor 136, the electronic communication interface 137, or any combination thereof may be integrated in one or more electronic units, circuits, or chips.

The processor 133 may include any device or combination of devices capable of manipulating or processing a signal or other information now-existing or hereafter developed, including optical processors, quantum processors, molecular processors, or a combination thereof. For example, the processor 133 may include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or any combination thereof. The processor 133 may be operatively coupled with the location unit 131, the memory 134, the electronic communication interface 137, the electronic communication unit 132, the user interface 135, the sensor 136, the powertrain 120, or any combination thereof. For example, the processor may be operatively coupled with the memory 134 via a communication bus 138.

The memory 134 may include any tangible non-transitory computer-usable or computer-readable medium, capable of, for example, containing, storing, communicating, or transporting machine readable instructions, or any information associated therewith, for use by or in connection with the processor 133. The memory 134 may be, for example, one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof.

The communication interface 137 may be a wireless antenna, as shown, a wired communication port, an optical communication port, or any other wired or wireless unit capable of interfacing with a wired or wireless electronic communication medium 150. Although FIG. 1 shows the communication interface 137 communicating via a single communication link, a communication interface may be configured to communicate via multiple communication links. The communication interface 137 may be in communication with a satellite. Although FIG. 1 shows a single communication interface 137, a vehicle may include any number of communication interfaces.

The communication unit 132 may be configured to transmit and/or receive signals via a wired or wireless electronic communication medium 150, such as via the communication interface 137. Although not explicitly shown in FIG. 1, the communication unit 132 may be configured to transmit, receive, or both via any wired or wireless communication medium, such as radio frequency (RF), ultraviolet (UV), visible light, fiber optic, wireline, satellite signals, or a combination thereof. For example, the communication unit 132 may be configured to transmit and/or receive telecommunication protocols such as 4G, 5G, Long Term Evolution (LTE), and/or 6G, among other examples. The communication unit 132 may be configured to communicate via sidelink networks using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols, among other examples. Although FIG. 1 shows a single communication unit 132 and a single communication interface 137, any number of communication units and any number of communication interfaces may be used. The communication unit 132 may include a dedicated short-range communications (DSRC) unit, an on-board unit (OBU), or a combination thereof.

The location unit 131 may determine geolocation information, such as longitude, latitude, elevation, direction of travel, or velocity, of the vehicle 100. For example, the location unit may include or be in communication with, a global positioning system (GPS) unit (which may be referred to as a “GPS receiver” or a “GPS device”), a global navigation satellite system (GNSS), a Wide Area Augmentation System (WAAS) enabled National Marine-Electronics Association (NMEA) unit, a radio triangulation unit, or a combination thereof. The location unit 131 can be used to obtain information that represents, for example, a current heading of the vehicle 100, a current position of the vehicle 100 in two or three dimensions, a current angular orientation of the vehicle 100, or a combination thereof.

The user interface 135 may include any unit capable of interfacing with a person, such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or any combination thereof. The user interface 135 may be operatively coupled with the processor 133, as shown, or with any other element of the controller 130. Although shown as a single unit, the user interface 135 may include one or more physical units. For example, the user interface 135 may include an audio interface for performing audio communication with a person and a touch display for performing visual and touch-based communication with the person. The user interface 135 may include multiple displays, such as multiple physically separate units, multiple defined portions within a single physical unit, or a combination thereof.

The sensor 136 may include one or more sensors, such as an array of sensors, which may be operable to provide information that may be used to control the vehicle. The sensors 136 may provide information regarding current operating characteristics of the vehicle 100. The sensor 136 can include, for example, a speed sensor, acceleration sensors, a steering angle sensor, traction-related sensors, braking-related sensors, steering wheel position sensors, eye tracking sensors, seating position sensors, LiDAR, GPS, GNSS, IMUs, cameras, or any sensor, or combination of sensors, operable to report information regarding some aspect of the current dynamic situation of the vehicle 100.

The sensor 136 may include one or more sensors operable to obtain information regarding the physical environment surrounding the vehicle 100. For example, one or more sensors may detect road geometry and features, such as lane lines, and obstacles, such as fixed obstacles, vehicles, and pedestrians. The sensor 136 can be or include one or more video cameras, laser-sensing systems, infrared-sensing systems, acoustic-sensing systems, or any other suitable type of on-vehicle environmental sensing device, or combination of devices, now known or later developed. In some embodiments, the sensors 136 and the location unit 131 may be a combined unit.

In some implementations, the controller 130 may include or interact with an in-vehicle infotainment system and/or a dynamic image generation system as described herein.

One or more of the wheels 140 may be a steered wheel, which may be pivoted to a steering angle under control of the steering unit 123, a propelled wheel, which may be torqued to propel the vehicle 100 under control of the transmission 122, or a steered and propelled wheel that may steer and propel the vehicle 100.

A vehicle may include units, or elements, not expressly shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

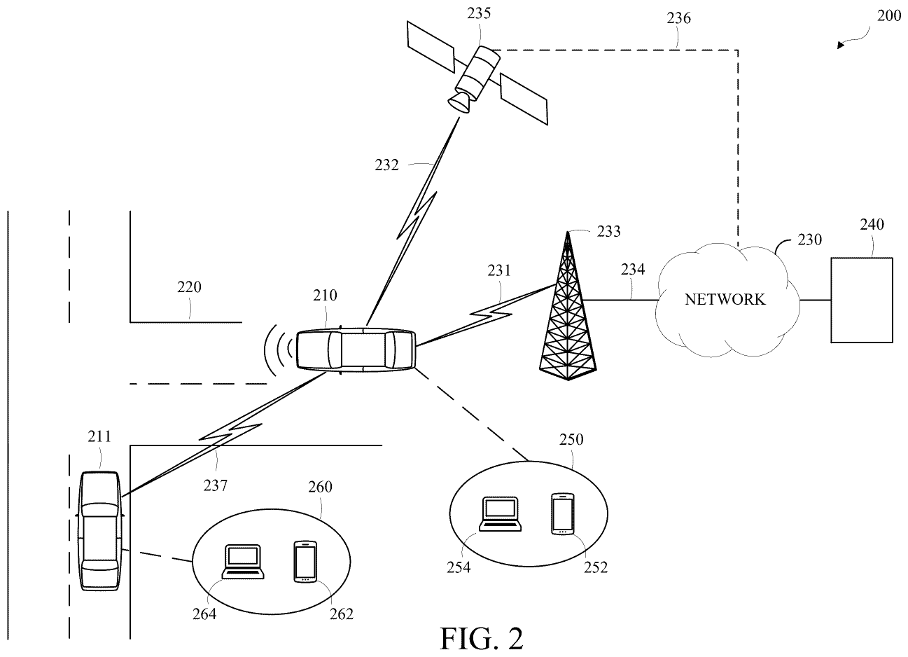

FIG. 2 is a diagram of an example of a portion of a vehicle transportation and communication system 200 in which the aspects, features, and elements disclosed herein may be implemented. The vehicle transportation and communication system 200 may include one or more vehicles 210/211, such as the vehicle 100 shown in FIG. 1, which may travel via one or more portions of one or more vehicle transportation networks 220, and may communicate via one or more electronic communication networks 230. Although not explicitly shown in FIG. 2, a vehicle may traverse an area that is not expressly or completely included in a vehicle transportation network, such as an off-road area.

The electronic communication network 230 may be, for example, a multiple access system and may provide for communication, such as voice communication, data communication, video communication, messaging communication, or a combination thereof, between the vehicle 210/211, one or more communication devices 240, and/or an operations center 242. For example, a vehicle 210/211 may receive information, such as information representing the vehicle transportation network 220, from a communication device 240 and/or the operations center 242 via the network 230.

The operations center 242 may include a controller apparatus 244, which may include some or all of the features of the controller 130 shown in FIG. 1. In some implementations, the operations center 242 and/or the controller apparatus 244 may be, be similar to, include, or be included in a VLA system. The controller apparatus 244 may be configured to monitor and coordinate the movement of vehicles, including connected vehicles and/or autonomous vehicles. The controller apparatus 244 may monitor the state or condition of vehicles, such as the vehicle 210, vehicle 211, and/or any number of external objects. The controller apparatus 244 may be configured to receive vehicle data and infrastructure data including vehicle velocity, vehicle location, vehicle orientation, vehicle operational state, vehicle destination, vehicle route, vehicle sensor data, external object velocity, external object location, external object orientation, external object operational state, external object destination, external object route, and/or external object sensor data, among other examples.

Further, the controller apparatus 244 may establish remote control over one or more vehicles, such as the vehicle 210, the vehicle 211, or external objects. In this way, the controller apparatus 244 may be used to teleoperate the vehicles or external objects from a remote location. The controller apparatus 244 may exchange (send or receive) state data with vehicles, external objects, and/or a computing device via a wireless communication link, such as the wireless communication link 231, or a wired communication link, such as the wired communication link 234. The operations center 242 and/or the controller apparatus 244 may include one or more server computing devices, which may exchange (send or receive) state signal data with one or more vehicles or computing devices).

In some embodiments, a vehicle 210/211 may communicate via a wired communication link (not shown), a wireless communication link 231/232/237, or a combination of any number of wired or wireless communication links. For example, as shown, a vehicle 210/211 may communicate via a terrestrial wireless communication link 231, via a non-terrestrial wireless communication link 232, or via a combination thereof. The terrestrial wireless communication link 231 may include an Ethernet link, a serial link, a Bluetooth link, an infrared (IR) link, a UV link, an RF link, or any link capable of providing for electronic communication.

A vehicle 210/211 may communicate with another vehicle 210/2110. For example, a host, or subject, vehicle (HV) 210 may receive one or more automated inter-vehicle messages, such as a basic safety message (BSM), from a remote, or target, vehicle (RV) 211, via a direct communication link 237, or via a network 230. For example, the remote vehicle 211 may broadcast the message to host vehicles within a defined broadcast range, such as 300 meters. In some embodiments, the host vehicle 210 may receive a message via a third party, such as a signal repeater (not shown) or another remote vehicle (not shown). A vehicle 210/211 may transmit one or more automated inter-vehicle messages periodically, based on, for example, a defined interval, such as 100 milliseconds.

Automated inter-vehicle messages may include vehicle identification information, geospatial state information, such as longitude, latitude, or elevation information, geospatial location accuracy information, kinematic state information, such as vehicle acceleration information, yaw rate information, velocity information, vehicle heading information, braking system status information, throttle information, steering wheel angle information, or vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state.

The vehicle 210 may communicate with the communications network 230 via an access point 233. The access point 233, which may include a computing device, may be configured to communicate with a vehicle 210, with a communication network 230, with one or more communication devices 240, or with a combination thereof via wired or wireless communication links 231/234. For example, the access point 233 may be a base station, a base transceiver station (BTS), a Node-B, an enhanced Node-B (eNode-B), a Home Node-B (HNode-B), a central unit (CU), a distributed unit (DU), a radio unit (RU), an NR network node, a 6G network node, a transmission reception point (TRP), a mobility element of a network, a core network node, a network element, a network equipment, a wireless router, a wired router, a hub, a relay, a switch, or any similar wired or wireless device. Although shown as a single unit in FIG. 2, an access point may include any number of interconnected elements. An access point may be stationary or mobile.

The vehicle 210 may communicate with the communications network 230 via a satellite 235 or other non-terrestrial communication device. The satellite 235, which may include a computing device, may be configured to communicate with a vehicle 210, with a communication network 230, with one or more communication devices 240, or with a combination thereof via one or more communication links 232/236. Although shown as a single unit in FIG. 2, a satellite may include any number of interconnected elements.

An electronic communication network 230 may be any type of network configured to provide voice, data, or any other type of electronic communication. For example, the electronic communication network 230 may include a local area network (LAN), a wide area network (WAN), a virtual private network (VPN), a mobile or cellular telephone network, the Internet, an Internet of Things (IoT) network, or any other electronic communication system. The electronic communication network 230 may use a communication protocol, such as transmission control protocol (TCP), user datagram protocol (UDP), internet protocol (IP), real-time transport protocol (RTP), HyperText Transport Protocol (HTTP), or a combination thereof. Although shown as a single unit in FIG. 2, an electronic communication network may include any number of interconnected elements.

The vehicle 210 may identify a portion or condition of the vehicle transportation network 220. For example, the vehicle 210 may include one or more on-vehicle sensors, such as sensor 136 shown in FIG. 1, which may include a velocity sensor, a wheel velocity sensor, a camera, a gyroscope, an optical sensor, a laser sensor, a radar sensor, a sonic sensor, or any other sensor or device or combination thereof capable of determining or identifying a portion or condition of the vehicle transportation network 220. The sensor data may include lane line data, remote vehicle location data, or both.

The vehicle 210 may traverse a portion or portions of one or more vehicle transportation networks 220 using information communicated via the network 230, such as information representing the vehicle transportation network 220, information identified by one or more on-vehicle sensors, or a combination thereof.

Although for simplicity FIG. 2 shows two vehicles 210, 211, one vehicle transportation network 220, one electronic communication network 230, one communication device 240, one operations center 242, and one controller apparatus 244, any number of vehicles, networks, computing devices, communication networks, operations centers, and/or controller apparatuses may be used. The vehicle transportation and communication system 200 may include devices, units, or elements not shown in FIG. 2. Although the vehicle 210 is shown as a single unit, a vehicle may include any number of interconnected elements.

Although the vehicle 210 is shown communicating with the communication device 240 via the network 230, the vehicle 210 may communicate with the communication device 240 via any number of direct or indirect communication links. For example, the vehicle 210 may communicate with the communication device 240 via a direct communication link, such as a Bluetooth communication link.

In some embodiments, a vehicle 210/211 may be associated with an entity 250/260, such as a driver, operator, or owner of the vehicle. In some embodiments, an entity 250/260 associated with a vehicle 210/211 may be associated with one or more personal electronic devices 252/254/262/264, such as a smartphone 252/262 or a computer 254/264. In some embodiments, a personal electronic device 252/254/262/264 may communicate with a corresponding vehicle 210/211 via a direct or indirect communication link. Although one entity 250/260 is shown as associated with a respective vehicle 210/211 in FIG. 2, any number of vehicles may be associated with an entity and any number of entities may be associated with a vehicle.

The vehicle transportation network 220 shows only navigable areas (e.g., roads), but the vehicle transportation network may also include one or more unnavigable areas, such as a building, one or more partially navigable areas, such as a parking area or pedestrian walkway, or a combination thereof. The vehicle transportation network 220 may also include one or more interchanges between one or more navigable, or partially navigable, areas. A portion of the vehicle transportation network 220, such as a road, may include one or more lanes and may be associated with one or more directions of travel.

A vehicle transportation network 220, or a portion thereof, may be represented as vehicle transportation network data. For example, vehicle transportation network data may be expressed as a hierarchy of elements, such as markup language elements, which may be stored in a database or file. For simplicity, the figures herein depict vehicle transportation network data representing portions of a vehicle transportation network 220 as diagrams or maps; however, vehicle transportation network data may be expressed in any computer-usable form capable of representing a vehicle transportation network, or a portion thereof. The vehicle transportation network data may include vehicle transportation network control information, such as direction of travel information, speed limit information, toll information, grade information, such as inclination or angle information, surface material information, aesthetic information, defined hazard information, or a combination thereof.

A portion, or a combination of portions, of the vehicle transportation network 220 may be identified as a point of interest or a destination. For example, the vehicle transportation network data may identify a building as a point of interest or destination. The point of interest or destination may be identified using a discrete uniquely identifiable geolocation. For example, the vehicle transportation network 220 may include a defined location, such as a street address, a postal address, a vehicle transportation network address, a GPS address, or a combination thereof for the destination.

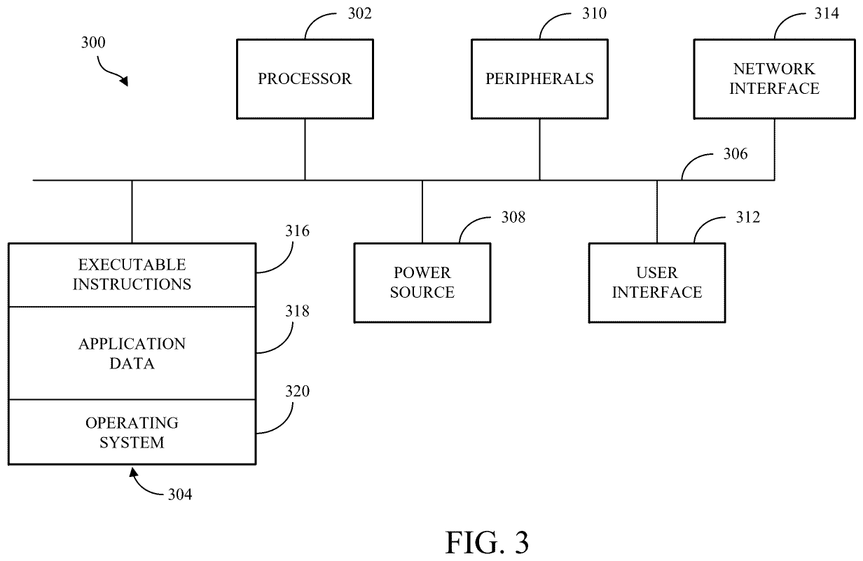

FIG. 3 shows a block diagram of an example of a computing device 300 capable of performing functions described herein. The computing device 300 may be, be similar to, include, or be included in, an apparatus for performing one or more methods, processes, algorithms, operations, tasks, and/or techniques, as described herein. The computing device 300 may be, be similar to, include, or be included in, a vehicle, a vehicle transportation and communication system (e.g., the vehicle transportation and communication system 200 shown in FIG. 2), a sensor, a communication device, a vehicle controller (e.g., the controller 130 shown in FIG. 1) and/or a vehicle computer, among other examples. The computing device 300 includes components or units, such as a processor 302, a memory 304, a bus 306, a power source 308, peripherals 310, a user interface 312, a network interface 314, other suitable components, or a combination thereof. One or more of the memory 304, the power source 308, the peripherals 310, the user interface 312, or the network interface 314 can communicate with the processor 302 via the bus 306.

The processor 302 may be a central processing unit, such as a microprocessor, and may include single or multiple processors having single or multiple processing cores. The processor 302 can include another type of device, or multiple devices, configured for manipulating or processing information. For example, the processor 302 can include multiple processors interconnected in one or more manners, including hardwired or networked. The operations of the processor 302 can be distributed across multiple devices or units that can be coupled directly or across a local area or other suitable type of network. The processor 302 can include a cache, or cache memory, for local storage of operating data or instructions.

The memory 304 includes one or more memory components, which may each be volatile memory or non-volatile memory. For example, the volatile memory can be random access memory (RAM) (e.g., a DRAM module, such as DDR SDRAM). In another example, the non-volatile memory of the memory 304 can be a disk drive, a solid state drive, flash memory, or phase-change memory. In some implementations, the memory 304 can be distributed across multiple devices. For example, the memory 304 can include network-based memory or memory in multiple clients or servers performing the operations of those multiple devices.

The memory 304 can include data for immediate access by the processor 302. For example, the memory 304 can include executable instructions 316, application data 318, and an operating system 320. The executable instructions 316 can include one or more application programs, which can be loaded or copied, in whole or in part, from non-volatile memory to volatile memory to be executed by the processor 302. For example, the executable instructions 316 can include instructions for performing techniques of this disclosure. In some implementations, the application data 318 can include functional programs, such as a computational programs, analytical programs, database programs, and so on. The operating system 320 can be, for example, Microsoft Windows®, Mac OS X®, or Linux®; an operating system for a mobile device, such as a smartphone or tablet device; or an operating system for a non-mobile device, such as a mainframe computer.

The power source 308 provides power to the computing device 300. For example, the power source 308 can be an interface to an external power distribution system. In another example, the power source 308 can be a battery, such as where the computing device 300 is a mobile device or is otherwise configured to operate independently of an external power distribution system. In some implementations, the computing device 300 may include or otherwise use multiple power sources. In some such implementations, the power source 308 can be a backup battery.

The peripherals 310 may include one or more sensors, detectors, or other devices configured for monitoring the computing device 300 or the environment around the computing device 300. For example, the peripherals 310 can include a geolocation component, such as a GPS location unit. In another example, the peripherals can include a temperature sensor for measuring temperatures of components of the computing device 300, such as the processor 302. In some implementations, the computing device 300 can omit the peripherals 310.

The user interface 312 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 314 provides a connection or link to a network (e.g., the electronic communication network 230 shown in FIG. 2). The network interface 314 can be a wired network interface or a wireless network interface. The computing device 300 can communicate with other devices via the network interface 314 using one or more network protocols, such as using Ethernet, TCP, IP, power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof. For example, the computing device 300 can communicate with a database server.

The network interface 314 may include a transceiver, which may include a transmitter or a receiver. In some configurations, one or a combination of antenna(s), modem(s), multiple input multiple output (MIMO) detectors, receive processors, transmit processors, and/or the transmit MIMO processors may be included in the transceiver. The transceiver may be under control of or used by one or more processors, and in some aspects in conjunction with processor-readable code stored in the memory, to perform aspects of the methods, processes, techniques, and/or operations described herein.

In the description herein, sentences describing a vehicle, a system, or a device as taking an action (such as performing, determining, initiating, receiving, calculating, deciding, etc.) are to be understood that some appropriate component of the vehicle, system, or device as taking the action. Such components may refer to hardware and/or software configured to take the action.

An apparatus, computing device (e.g., the computing device 300), system, and/or vehicle, described herein may include one or more chips, system-on-chips (SoCs), chipsets, packages, and/or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include a memory system in the form of one or more memory devices, memory blocks, memory elements or other discrete gate or transistor logic or circuitry, each of which may include tangible storage media such as RAM or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The apparatus may include or may be included in a housing that houses components associated with the apparatus including the processing system.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 3, such as a single processor or a combination of multiple different processors. Reference to “one or more processors” should be understood to refer to any one or more of the processors described in connection with FIG. 3.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 3. For example, an operation described as being performed by one or more memories can be performed by the same subset of the one or more memories or different subsets of the one or more memories.

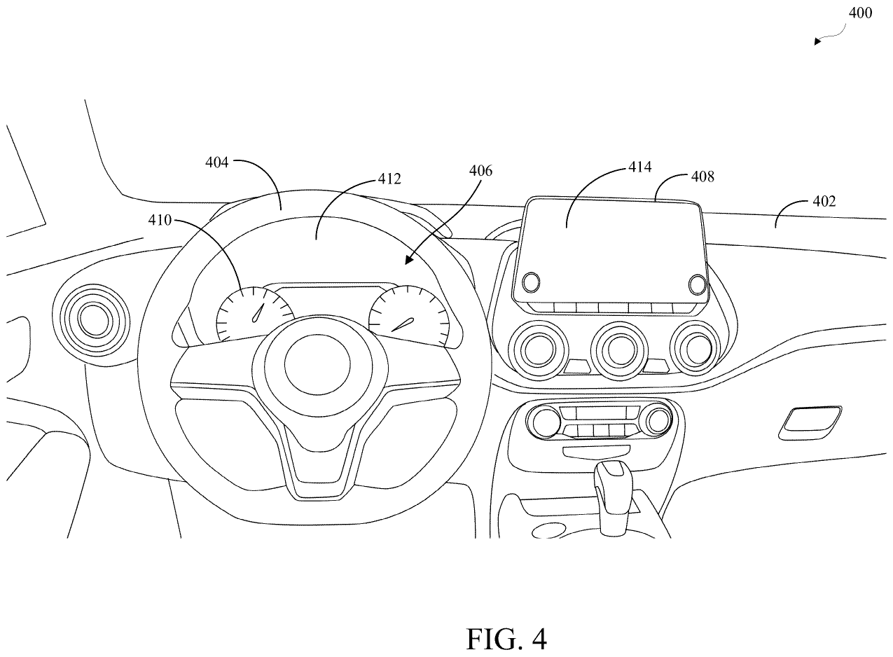

FIG. 4 illustrates an orthogonal front view of a vehicle interior 400. The vehicle interior 400 includes a dashboard 402 that houses various display and control components. The vehicle interior 400 may represent a portion of a cabin of a vehicle such as the vehicle 100 shown in FIG. 1. In some implementations, the dashboard 402 may be a single integrated unit, while in other implementations, it may be composed of multiple modular sections that can be customized or replaced individually. The dashboard 402 may be constructed from various materials, such as plastic, metal, carbon fiber, or a combination thereof, depending on the specific vehicle design and requirements.

A steering wheel 404 is positioned in front of the driver's position and includes a gauge 410 integrated into its design. In some implementations, the steering wheel 404 may be a traditional circular design, while in others, it may have a more unconventional shape, such as a yoke or a butterfly design. The steering wheel 404 may incorporate various controls, such as buttons, switches, or touch-sensitive surfaces, allowing the driver to interact with vehicle systems without removing their hands from the wheel. The gauge 410 integrated into the steering wheel 404 may display various types of information, such as vehicle speed, engine revolutions per minute (RPM), or warning indicators. In some implementations, the gauge 410 may be a physical analog display, while in others, it may be a digital display that can be customized to show different information based on driver preferences or vehicle operating conditions.

An instrument cluster 406 is located behind the steering wheel 404, providing vehicle information to the driver. In some implementations, the instrument cluster 406 may consist of traditional analog gauges, while in others, it may be a fully digital display capable of showing a wide range of information and customizable layouts. The instrument cluster 406 may display information such as vehicle speed, engine temperature, fuel level, and various warning indicators. In some implementations, the instrument cluster 406 may incorporate augmented reality features, overlaying information onto a view of the road ahead. The instrument cluster 406 may also be capable of displaying navigation information, entertainment system controls, or vehicle diagnostic data, depending on the specific implementation and user preferences.

An in-vehicle infotainment device 408 is mounted in the center portion of the dashboard 402. In some implementations, the in-vehicle infotainment device 408 may be a fixed display integrated into the dashboard, while in others, it may be a removable tablet-like device that can be detached for use outside the vehicle. The in-vehicle infotainment device 408 may provide access to various functions such as navigation, media playback, climate control, and vehicle settings. In some implementations, the device may support voice commands, gesture controls, or haptic feedback to enhance user interaction. The in-vehicle infotainment device 408 may also serve as an interface for connected car features, allowing integration with smartphones, cloud services, or other external devices and platforms.

The figure shows two display devices—display device 412 and display device 414—which are integrated into the dashboard 402 layout. As shown, the display device 412 may be integrated into the instrument cluster 406 and the display device 414 may be integrated into the infotainment device 408. In some implementations, these display devices may be separate physical screens, while in others, they may be part of a single large display that can be divided into multiple virtual screens. The display devices 412 and 414 may serve various purposes depending on the specific vehicle configuration. For example, display device 412 may be dedicated to showing vehicle status information, such as energy consumption in an electric vehicle or advanced driver assistance system (ADAS) visualizations. Display device 414 may be used for passenger entertainment, climate control settings, or as an extension of the infotainment system. In some implementations, the content shown on these display devices may be dynamically reconfigurable based on driving conditions, user preferences, or specific vehicle modes (e.g., sport mode, eco mode).

The display devices 412, 414 are positioned to be easily visible to the driver while maintaining a clean, integrated appearance within the dashboard 402. In some implementations, these displays may incorporate anti-glare coatings or adjustable brightness settings to ensure visibility in various lighting conditions. The positioning of the display devices may be optimized to minimize driver distraction while still providing easy access to important information and controls. In some implementations, the display devices may support touch input, while in others, they may be controlled via physical buttons, voice commands, or gesture recognition systems integrated elsewhere in the vehicle interior.

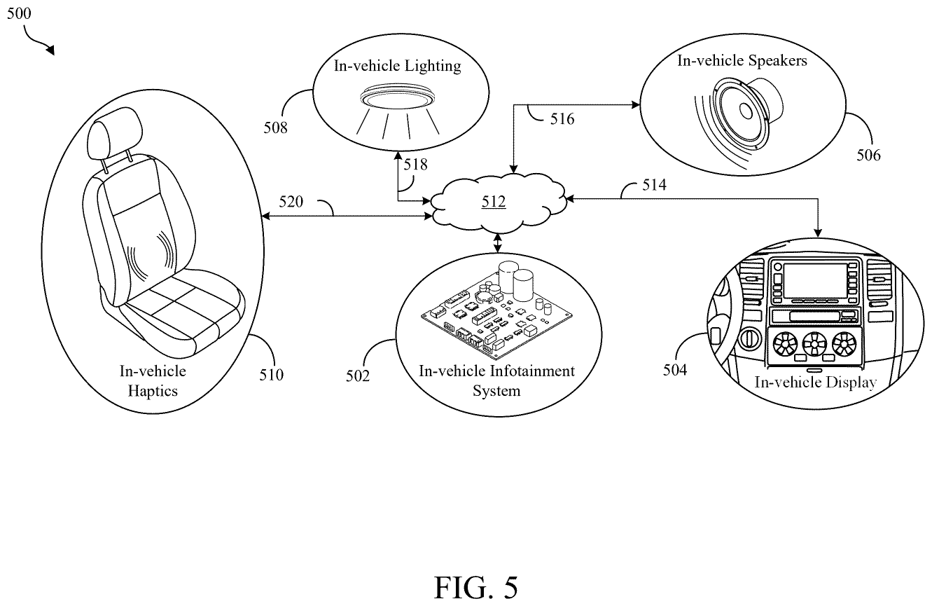

FIG. 5 illustrates a block diagram of an operating environment 500 for a vehicle feedback system. The operating environment 500 may include various interconnected components that work together to provide dynamic visual, auditory, and haptic feedback to vehicle occupants based on vehicle operating conditions and environmental factors. The operating environment 500 may be implemented in a vehicle such as the vehicle 100 shown in FIG. 1. In some implementations, the one or more aspects of the operating environment 500 may be implemented using one or more components of the computing device 300 shown in FIG. 3.

In some implementations, the operating environment 500 may include an infotainment system 502, which serves as the central processing unit for the vehicle feedback system. The infotainment system 502 may be a computer system comprising one or more processors, memory devices, and communication interfaces. In some implementations, the infotainment system 502 may be integrated into the vehicle's main computer system, while in other implementations, it may be a separate, dedicated unit. The infotainment system 502 may run various software applications and algorithms to process input data, generate feedback signals, and coordinate the activities of other components in the operating environment 500.

A display interface 504 may be communicatively coupled to the infotainment system 502. In some implementations, the display interface 504 may include one or more visual output devices, such as LCD screens, OLED displays, or HUD units. The display interface 504 may be configured to present various types of visual information to vehicle occupants, including vehicle status information, navigation data, entertainment content, and dynamically generated graphics based on current driving conditions. In some implementations, the display interface 504 may support touch input, allowing users to interact with the system through gestures and taps. In some implementations, the display interface 504 may be a non-interactive screen, with user input handled through separate controls or voice commands.

The operating environment 500 may also include a speaker system 506 for providing auditory feedback to vehicle occupants. In some implementations, the speaker system 506 may comprise a set of strategically placed speakers throughout the vehicle cabin, capable of producing a wide range of sounds, from simple alert tones to complex, spatialized audio environments. The speaker system 506 may be used to convey important information to the driver, such as navigation instructions or warning signals, as well as to create immersive audio experiences that complement the visual feedback provided by the display interface 504. In some implementations, the speaker system 506 may include bone conduction technology or directional sound beams to deliver personalized audio feedback to specific occupants without disturbing others.

A lighting system 508 may be incorporated into the operating environment 500 to provide visual cues and enhance the overall feedback experience. In some implementations, the lighting system 508 may consist of ambient lighting elements integrated into various parts of the vehicle interior, such as the dashboard, door panels, and ceiling. These lighting elements may be capable of producing a wide range of colors and intensity levels, allowing for subtle or dramatic changes in the vehicle's interior atmosphere. The lighting system 508 may be used to reinforce information presented on the display interface 504, highlight potential hazards, or create mood lighting based on driver preferences or current driving conditions. In some implementations, the lighting system 508 may extend to the vehicle's exterior, using dynamic lighting effects to communicate the vehicle's status or intentions to other road users.

The operating environment 500 may also include a haptic system 510 for providing tactile feedback to vehicle occupants. In some implementations, the haptic system 510 may comprise actuators integrated into the vehicle's seats, steering wheel, and other contact surfaces. These actuators may be capable of producing various types of vibrations, pulses, or other tactile sensations to convey information or alerts to the driver and passengers. For example, the haptic system 510 may provide subtle vibrations in the steering wheel to indicate lane departure or deliver seat vibrations to alert the driver of potential collisions. In some implementations, the haptic system 510 may include more advanced technologies such as shape-changing surfaces or force feedback systems to create more complex and informative tactile experiences.

A control module 512 may be included in the operating environment 500 to manage communication and coordination between the various components. In some implementations, the control module 512 may be a separate hardware unit with its own processor and memory, while in other implementations, it may be a software module running within the infotainment system 502. The control module 512 may be responsible for routing signals between components, synchronizing feedback across different modalities, and ensuring that the overall feedback experience is coherent and effective. For example, the control module 512 may receive an audio signal 514 from the infotainment system 502 and coordinate it with corresponding visual effects on the display interface 504 and lighting system 508.

In some implementations, the control module 512 may also manage various signal paths, such as a speaker signal 516 sent to the speaker system 506, a lighting signal 518 directed to the lighting system 508, and a haptic signal 520 transmitted to the haptic system 510. These signals may be generated based on complex algorithms that take into account current vehicle data, user preferences, and environmental conditions to create a dynamic and responsive feedback environment. The control module 512 may also be responsible for prioritizing different types of feedback based on the urgency of the information and the current cognitive load on the driver, ensuring that important alerts are always delivered effectively without causing unnecessary distraction.

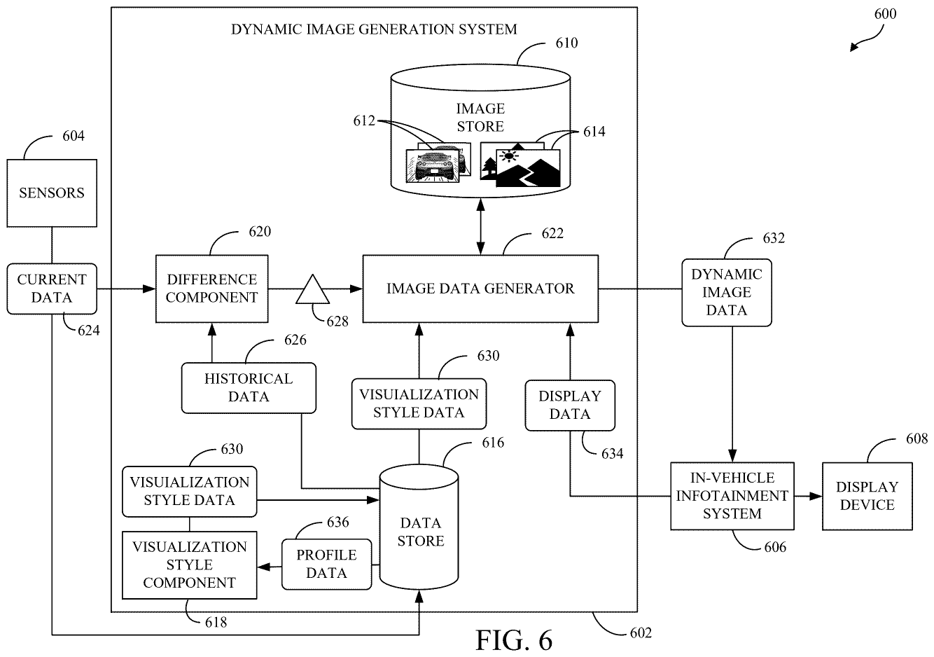

FIG. 6 is a block schematic diagram illustrating an example 600 associated with dynamic image generation for a vehicle display system. As shown, the example 600 includes a dynamic image generation system 602, sensors 604, and an in-vehicle infotainment system 606 with a display device 608. The dynamic image generation system 602 may be implemented in a vehicle, such as the vehicle 100 shown in FIG. 1. In some implementations, one or more components of the in-vehicle infotainment system 606 may be included as part of the dynamic image generation system 602. For example, the dynamic image generation system 602 may be coupled to or integrated with one or more processors or other components of the in-vehicle infotainment system 606. In some implementations, one or more components of example 600 may be implemented using a computing device, such as the computing device 300 shown in FIG. 3.

In some implementations, the dynamic image generation system 602 may be a computer system comprising one or more processors, memory devices, and communication interfaces. The dynamic image generation system 602 may be integrated into the vehicle's controller or may be a separate, dedicated unit. In some implementations, the dynamic image generation system 602 may be distributed across multiple computing devices within the vehicle or may leverage cloud computing resources.

The dynamic image generation system 602 may include an image store 610 that stores images such as, for example, vehicle operation context images 612 or external environment context images 614, a data store 616, a visualization style component 618, a difference component 620, and an image data generator 622. In some implementations, one or more components of the dynamic image generation system 602 may be implemented as software modules executing on the one or more processors described in connection with the computing device 300 shown in FIG. 3. In some implementations, two or more components of the dynamic image generation system 602 may be combined into a single component. In some implementations, one or more components of the dynamic image generation system 602, including the image store 610, the data store 616, the visualization style component 618, the difference component 620, and the image data generator 622, may be omitted from the dynamic image generation system 602.

The sensors 604 may include any number of various types of sensing devices configured to obtain current data 624 related to the operation of the vehicle or the environment outside of the vehicle. In some implementations, the sensors 604 may include radar devices, LiDAR devices, camera devices, proximity sensors, vehicle control devices, weather monitoring devices, motion sensors, inertial measurement units (IMUs), or geo-location devices. For example, a LIDAR sensor may provide detailed 3D mapping of the vehicle's surroundings, while a weather monitoring device may detect current precipitation levels or visibility conditions.

In some implementations, the sensors 604 may include various types of in-vehicle sensors configured to gather data regarding the vehicle's internal environment and its occupants. These in-vehicle sensors may include seat occupancy sensors, which may detect the presence of occupants and measure their weight distribution across different seats. In some implementations, the sensors may include seatbelt sensors, which may monitor whether seatbelts are fastened and assess the tension applied to them. Interior temperature and humidity sensors may be employed to measure cabin climate conditions. Carbon dioxide sensors may be utilized to monitor air quality and respiration levels of the occupants. Infrared cameras may be configured to detect heat signatures of occupants and objects within the vehicle. In some implementations, microphones distributed throughout the cabin may capture voice commands and ambient noise levels.

Additional sensors may include steering wheel sensors capable of measuring grip pressure and detecting hand positions. Eye-tracking cameras may be used to monitor the driver's gaze and attention. Biometric sensors integrated into the steering wheel or seats may measure physiological data such as heart rate, blood pressure, or skin conductivity. Gesture recognition cameras may interpret hand and body movements for control inputs. Other types of in-vehicle sensors may also be incorporated, depending on the implementation.

In some implementations, the dynamic image generation system may utilize sensors specifically designed to identify the driver and customize the visual output accordingly. For example, facial recognition cameras may match the driver's face to stored profile images. Fingerprint sensors integrated into the steering wheel or start button may authenticate the driver's identity. Voice recognition systems may be employed to identify the driver based on unique vocal characteristics. Weight sensors in the driver's seat may be used, potentially in combination with other identifiers, to determine the most likely driver profile. Wearable device detectors may recognize specific smartwatches or fitness trackers associated with different drivers. Additionally, radio-frequency identification (RFID) sensors may detect personalized key fobs or cards carried by various drivers.

In some implementations, these driver identification sensors may work in conjunction with the dynamic image generation system to automatically load personalized visualization styles, preferred information layouts, or custom color schemes based on the identified driver. The system may adjust the content and complexity of the displayed information based on the driver's known preferences or experience level.

The in-vehicle infotainment system 606 may serve as the primary interface for presenting dynamic visual content to vehicle occupants. In some implementations, the in-vehicle infotainment system 606 may be, be similar to, include, or be included in the in-vehicle infotainment device 408 shown in FIG. 4 and/or the infotainment system 502 shown in FIG. 5. In some implementations, the in-vehicle infotainment system 606 may include multiple display devices, such as an instrument cluster display, a center console display, and an HUD. The display device 608 shown in the diagram may represent any one or a combination of these display types. In some implementations, the display device 608 may utilize advanced display technologies such as OLED screens for improved contrast and color reproduction or transparent displays integrated into the vehicle's windows for augmented reality applications.

The image store 610 may contain a repository of visual elements and templates used in generating dynamic image content. As shown in the diagram, the image store 610 may include operation context images 612 and external environment context images 614. Operation context images 612 may include visual representations of various vehicle operating states, such as acceleration, braking, or turning. Environment context images 614 may include visual elements representing different weather conditions, road types, or time of day. In some implementations, the image store 610 may be regularly updated with new visual elements to ensure fresh and engaging content for drivers.

In addition to complete images, the image store 610 may contain a variety of image augmentations such as masks, filters, and overlays. These augmentations may be used to modify or enhance base images in real-time, allowing for greater flexibility and customization of the visual output. For example, the system may store a set of weather-related filters that can be applied to landscape images to simulate different atmospheric conditions. Masks may be used to isolate specific areas of an image for dynamic effects, such as highlighting road signs or potential hazards in the visual representation of the environment.

The image store 610 may obtain images through various methods to maintain a diverse and up-to-date repository of visual elements. In some implementations, the image store 610 may be connected to a cloud-based service that regularly pushes new image content to the vehicle's local storage. This cloud service may aggregate images from multiple sources, including professional designers, crowd-sourced contributions, and automated generation algorithms. The system may also leverage machine learning techniques to analyze the vehicle's typical routes and environments, proactively downloading relevant image content based on predicted future scenarios.

The image store 610 may also obtain image data from image data generation tools that can create or modify images on-the-fly based on current data inputs. These tools may use parametric models to generate textures, patterns, or even entire scenes that reflect the current vehicle state or environmental conditions. For instance, a road texture generator may adjust the appearance of the displayed road surface based on current speed, weather conditions, or road type, among other examples. This approach may allow the system to produce highly specific and relevant visual content without requiring an extensive pre-rendered image library, potentially reducing storage requirements and improving system responsiveness.

The data store 616 may contain historical data 626 related to vehicle operation and environmental conditions. This historical data may be used as a baseline for comparison with current data to determine changes or anomalies in vehicle operation or environmental conditions. In some implementations, the data store 616 may utilize machine learning algorithms to continuously refine and update its historical data models based on new information gathered during vehicle operation.

The historical data 626 stored in the data store 616 may include a variety of information related to past vehicle operations and environmental conditions. For example, the historical data may include vehicle speed profiles for different road types, such as highways, city streets, or rural roads. The historical data 626 may include acceleration and deceleration patterns associated with various driving scenarios, such as merging onto highways or approaching intersections. Fuel consumption or energy usage data for electric vehicles may be correlated with factors like driving style, route characteristics, and weather conditions. Steering inputs and vehicle dynamics for different road geometries, including curves, roundabouts, or straight sections, may be recorded as historical data 626.

The historical data 626 may reflect patterns of driver behavior, such as preferred following distances, lane positioning, and overtaking frequencies. Historical weather data for frequently traveled routes, including temperature ranges, precipitation patterns, and visibility conditions, may also be stored as historical data 626. Traffic flow information specific to times of day, days of the week, or seasonal variations on commonly used roads may be included in the historical data 626. In some implementations, past interactions with ADAS, such as the frequency of lane departure warnings or adaptive cruise control usage, may be tracked and recorded as historical data 626. Maintenance-related data, such as oil change intervals, tire pressure fluctuations, and battery performance for electric vehicles, may be included in the historical data 626.

Other types of historical data 626 may include cabin environment preferences, such as typical climate control settings based on weather conditions or times of day, and audio system usage patterns, including volume levels, preferred music genres, or podcast listening habits. Parking behavior data, such as preferred parking locations, frequency of parallel parking, and usage of parking assistance features, may be recorded as historical data 626. The frequency and duration of rest stops during long journeys, potentially correlated with the time of day or trip length, may form part of the historical data. Information on road surface conditions, such as commonly encountered potholes, rough patches, or construction zones on regular routes, may be captured as historical data 626. In some implementations, patterns of interaction with the infotainment system, such as frequently used features or typical information queries during different types of trips, may be included in the historical data 626.

In some implementations, the historical data 626 may be aggregated across multiple drivers or vehicles to identify broader trends and patterns. In other implementations, the data may be specific to individual drivers to enable personalized dynamic image generation. This data may facilitate the optimization of vehicle operations and improve the driving experience by tailoring it to specific environmental conditions, routes, and driver preferences.

A visualization style component 618 may be configured to determine the overall aesthetic and functional approach to presenting information visually. In some implementations, the visualization style component 618 may select from a set of preconfigured visualization styles based on factors such as driver preferences, vehicle type, or current operating context. For example, a sporty visualization style might use bold colors and dynamic animations, while a more conservative style might use muted colors and subtle transitions. The visualization style component 618 may also incorporate profile data 636, allowing for personalized visual experiences based on individual driver preferences or characteristics.

The visualization style component 618 may incorporate a modular design, allowing for easy addition or modification of visualization styles. In some implementations, the visualization style component 618 may include a style library containing various predefined visual themes, each with its own set of color palettes, typography, animation parameters, or layout templates. These themes may range from minimalist designs focused on essential information to more elaborate styles that incorporate detailed graphics and animations. The visualization style component 618 may also include a style selection algorithm that evaluates current driving conditions, vehicle status, or user preferences to determine the most appropriate visualization style for the given context.

In some cases, the visualization style component 618 may utilize machine learning techniques to adapt and evolve styles over time based on user interactions and feedback. For example, the visualization style component 618 may track which visual elements or styles the driver interacts with most frequently or finds most helpful, and gradually adjust the presentation to emphasize these aspects. This adaptive approach may allow the system to fine-tune its visual output to better match individual driver preferences and information processing styles, potentially improving the overall user experience and effectiveness of the dynamic image generation system.

The visualization style component 618 may incorporate real-time style blending capabilities. In some implementations, this feature may allow for smooth transitions between different visualization styles as driving conditions or contexts change. For instance, when transitioning from a city environment to a highway, the component may gradually shift from a detailed, information-rich urban style to a more streamlined, speed-focused highway style. This blending may be achieved through interpolation of color schemes, gradual transformation of graphical elements, or dynamic adjustment of information density and layout.

In some aspects, the visualization style component 618 may support extensibility through a plugin architecture. This design may allow third-party developers or vehicle manufacturers to create and integrate custom visualization styles tailored to specific vehicle models, brand identities, or user demographics. For example, a performance car manufacturer may develop a race-inspired visualization style that emphasizes dynamic performance metrics, while an electric vehicle brand may create styles that highlight energy efficiency and range information. The plugin architecture may also facilitate the integration of styles that complement specific infotainment features or connected car services, providing a cohesive visual experience across all aspects of the vehicle's digital interface.

A difference component 620 may be responsible for determining the difference between current data 624 and historical data 626. This component may generate a difference vector 628 that quantifies changes in vehicle operation or environmental conditions. In some implementations, the difference component 620 may utilize advanced statistical analysis techniques or machine learning algorithms to identify subtle patterns or trends in the data that may not be immediately apparent through simple comparison.

The difference component 620 may employ various techniques to analyze and quantify the differences between current data 624 and historical data 626. In some implementations, the difference component 620 may use simple statistical methods, such as calculating the mean and standard deviation of historical data for each parameter, and then comparing current values to determine if they fall outside a predefined range. For example, if the average historical speed on a particular road segment is 60 mph with a standard deviation of 5 mph, a current speed of 75 mph may be flagged as a significant difference.

In some implementations, the difference component 620 may utilize machine learning algorithms, such as anomaly detection models, to identify unusual patterns or deviations in the current data. These models may be trained on historical data to learn normal operating conditions and can then detect when current data deviates from these learned patterns. For instance, a neural network may be trained to recognize typical acceleration patterns for a specific driver on various road types. If the current acceleration data shows an unusual pattern, such as frequent rapid accelerations and decelerations in a highway environment, the model may flag this as a significant difference.

The difference component 620 may also incorporate time-series analysis techniques to account for temporal patterns and trends in the data. In some cases, the component may use methods like seasonal decomposition of time series (STL) or autoregressive integrated moving average (ARIMA) models to separate long-term trends, seasonal patterns, and short-term fluctuations in the historical data. This approach may allow the system to identify differences that are significant within the context of time-varying patterns. For example, the system may recognize that while current traffic congestion is higher than the historical average for a given road segment, it is within normal ranges for that time of day and day of the week.

In some implementations, the difference component 620 may generate a multidimensional difference vector 628 that captures changes across multiple parameters simultaneously. This vector may include normalized difference scores for various aspects of vehicle operation and environmental conditions, allowing for a more comprehensive representation of the current state relative to historical norms. The component may use techniques like principal component analysis (PCA) or t-distributed stochastic neighbor embedding (t-SNE) to reduce the dimensionality of this vector while preserving important relationships between parameters. This condensed representation may then be used by other components of the system to generate appropriate visual feedback that reflects the most significant changes in the vehicle's operating context. In some implementations, the difference vector 628 may include only a single scalar value, and in other implementations, the difference vector 628 may include any number of values.

An image data generator 622 may be responsible for creating the final dynamic image data 632 based on inputs from various components of the system. In some implementations, the image data generator 622 may utilize advanced computer graphics techniques, such as real-time ray tracing or procedural generation, to create highly detailed and responsive visual content. The image data generator 622 may also incorporate machine learning models to predict and pre-generate visual content based on anticipated changes in vehicle operation or environmental conditions, potentially reducing system latency.

The image data generator 622 may operate by synthesizing inputs from multiple system components to create dynamic visual content. In some implementations, the image data generator 622 may utilize a layered approach, where base images or templates are selected from the image store 610 based on the current visualization style, and then modified or augmented according to the difference vector 628. For example, if the difference vector 628 indicates a significant increase in vehicle speed, the image data generator 622 may apply motion blur effects or adjust the perspective of landscape elements in the visual output to convey a sense of increased velocity.

In some cases, the image data generator 622 may employ procedural generation techniques to create visual elements on-the-fly. This approach may be particularly useful for generating dynamic environmental effects that correspond to current conditions. For instance, if the difference vector 628 indicates a change in weather conditions, the image data generator 622 may procedurally generate appropriate visual effects such as rain droplets, snow accumulation, or changes in lighting conditions. The parameters for these procedural algorithms may be influenced by both the current data 624 and the selected visualization style, ensuring that the generated elements are contextually appropriate and visually cohesive.

The image data generator 622 may also incorporate real-time 3D rendering techniques to create more immersive and responsive visual content. In some implementations, the system may maintain a simplified 3D model of the vehicle and its immediate surroundings, which can be dynamically updated based on sensor data and the difference vector 628. The image data generator 622 may then render this 3D scene from various virtual camera perspectives, allowing for smooth transitions between different views or the creation of augmented reality overlays that blend seamlessly with the real world visible through the vehicle's windows.

In alternative implementations, the image data generator 622 may utilize machine learning models, such as auto regression models, diffusion models, generative adversarial networks (GANs) or variational autoencoders (VAEs), to create novel visual content based on the inputs it receives. These models may be trained on large datasets of driving scenarios and corresponding visualizations, allowing the models to generate appropriate visual representations for a wide range of conditions. The difference vector 628 and visualization style data 630 may serve as conditioning inputs for these generative models, guiding the creation of visual content that accurately reflects the current driving context and desired aesthetic. For example, a GAN-based image generator may be able to synthesize realistic-looking gauge clusters or environmental visualizations that smoothly adapt to changing conditions without relying on a fixed set of pre-rendered assets.

The image data generator 622 may employ various machine learning techniques to continually refine and retrain its models, enhancing the quality and relevance of the generated visual content over time. In some implementations, supervised learning approaches may be utilized to improve the accuracy of the image generation process. For instance, the system may collect feedback from drivers or passengers about the clarity and effectiveness of the displayed information. This labeled data may then be used to train the models, allowing them to better understand which visual representations are most effective for conveying specific types of information in different driving contexts. The supervised learning process may involve techniques such as convolutional neural networks (CNNs) for image recognition and generation, or recurrent neural networks (RNNs) for sequence-based data like time-series of vehicle telemetry.

Unsupervised learning techniques may also play a role in refining the image data generator's models. These methods may be particularly useful for discovering patterns and relationships in the input data that may not be immediately apparent. For example, clustering algorithms may be applied to identify common driving scenarios or environmental conditions that warrant similar visual treatments. Dimensionality reduction techniques like autoencoders may be employed to compress and reconstruct complex sensor data, potentially uncovering latent features that can inform the image generation process. By leveraging unsupervised learning, the image data generator 622 may adapt to new situations and generate novel visualizations without requiring explicit labeling of every possible scenario.

In some implementations, reinforcement learning may be incorporated to optimize the image generation process based on long-term user engagement. The system may define a reward function that takes into account factors such as driver attention, reaction times, and overall satisfaction with the interface. As the vehicle operates, the reinforcement learning algorithm may experiment with subtle variations in the generated visuals, learning which approaches lead to the best outcomes over time. This may allow the system to autonomously discover effective strategies for presenting information in different contexts, potentially uncovering innovative visualization techniques that human designers might not have considered. The reinforcement learning approach may be particularly valuable for adapting to individual driver preferences and habits, creating a highly personalized and efficient information display system.

In operation, the dynamic image generation system 602 may receive current data 624 from the sensors 604, which may include real-time information about vehicle speed, acceleration, weather conditions, road surface conditions, and other relevant factors. In some implementations, the current data 624 may also include information from V2V or V2I communication systems, providing a broader context for the vehicle's current operating environment. The system may utilize historical data 626 stored in the data store 616 to provide context and enable the identification of changes or anomalies in vehicle operation or environmental conditions. In some implementations, the historical data 626 may include not only information from the current vehicle but also aggregated data from multiple vehicles, allowing for more robust pattern recognition and anomaly detection.

The difference vector 628 generated by the difference component 620 may be used to inform the selection and modification of visual elements in the dynamic image content. In some implementations, the difference vector 628 may be multidimensional, capturing changes across multiple parameters simultaneously. This could allow for more nuanced and informative visual representations that reflect the complex interplay of various factors affecting vehicle operation.

The image data generator 622 may generate dynamic image data 632 based on the difference vector and visualization style data 630. Visualization style data 630 may be produced by the visualization style component 618 and may define the overall look and feel of the dynamic image content. In some implementations, the visualization style data 630 may include not only static visual properties but also dynamic elements such as animation curves, transition effects, or rules for how visual elements should respond to changes in the difference vector 628.

The dynamic image data 632 may be output to the in-vehicle infotainment system 606 for display. In some implementations, the dynamic image data 632 may be in a standardized format that can be interpreted by various types of display devices, allowing for flexibility in the vehicle's display configuration. The dynamic image data 632 may include metadata that provides context or instructions for how the visual content should be presented or interacted with.

The display data 634 represents the final visual output presented to the vehicle occupants via the display device 608. In some implementations, the display data 634 may be further processed or optimized by the in-vehicle infotainment system 606 to account for specific display hardware characteristics or to integrate with other information being presented to the driver.

In some implementations, the dynamic image content may incorporate interactive elements that allow the driver to engage with the displayed information. For example, the system may include touch-sensitive areas on the display device 608 that respond to driver input, enabling the user to access additional details or customize the presentation of information. The interactive features may allow drivers to prioritize certain types of information, adjust the level of detail presented, or switch between different visualization modes based on their preferences or current driving conditions. In some cases, gesture recognition technology may be integrated into the system, allowing drivers to interact with the dynamic image content through hand movements or eye tracking, potentially reducing the need for direct physical contact with the display.

The system may also provide mechanisms for drivers to offer feedback on the effectiveness and usability of the dynamic image content. This feedback loop may be implemented through voice commands, touch interactions, or post-drive surveys presented on the display device 608. In some implementations, the system may track implicit feedback metrics such as how often a driver interacts with certain elements of the display or how quickly they respond to alerts presented through the dynamic image content. This continual feedback mechanism may allow the system to adapt and refine its visualization strategies over time, tailoring the presentation of information to individual driver preferences and improving overall user experience.

In addition to dynamic image content, the system may generate and present dynamic content in other modalities to create a more immersive and informative driving experience. For instance, dynamic audio content may be generated to complement the visual information, providing auditory cues or spoken notifications that correspond to changes in vehicle status or environmental conditions. Similarly, dynamic haptic content may be produced through the vehicle's haptic feedback systems, such as vibrations in the steering wheel or seat, to convey information in a tactile manner. These multi-modal dynamic content streams may work in concert to provide a rich, intuitive interface that enhances driver awareness and engagement without relying solely on visual information.

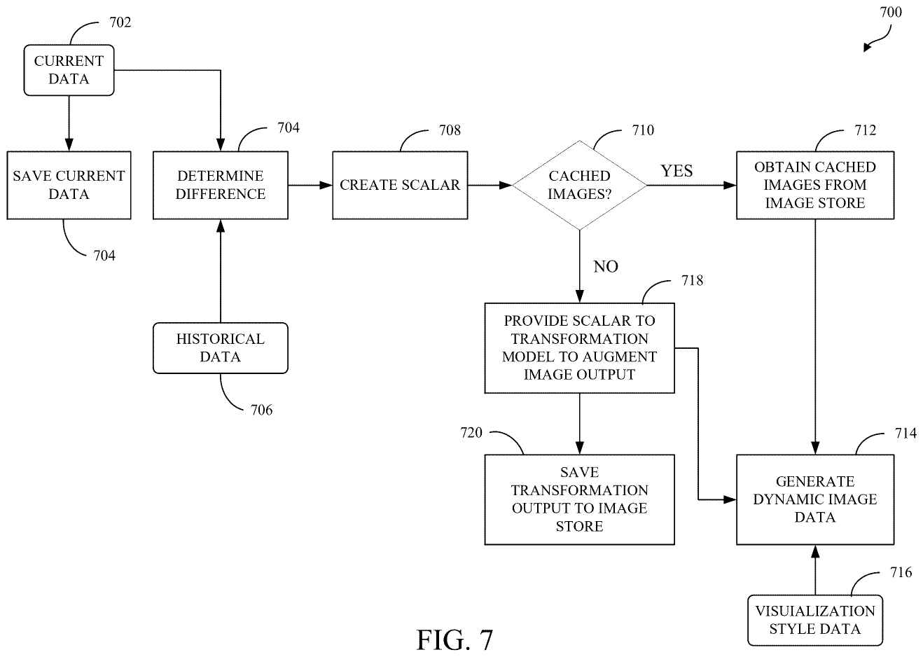

FIG. 7 is a flow diagram illustrating an example process 700 associated with dynamic image generation for a vehicle display system, in accordance with implementations of the present disclosure. The process 700 may be implemented by the dynamic image generation system 602 shown in FIG. 6, or by other suitable processing circuitry. In some implementations, the process 700 may be executed continually during vehicle operation, while in other implementations, it may be triggered by specific events or conditions.

The process 700 begins with current data 702 being received and saved as current data 704. In some implementations, the current data 702 may be obtained from various sensors 604 as shown in FIG. 6, such as radar devices, LIDAR devices, camera devices, or vehicle control devices. The current data 702 may include information related to vehicle speed, acceleration, weather conditions, road surface conditions, or other relevant factors. In some implementations, the current data 702 may also include information from V2V or V2I communication systems, providing a broader context for the vehicle's current operating environment.

Historical data 706 is also input into the process 700. In some implementations, the historical data 706 may be stored in a data store such as, for example, the data store 616 shown in FIG. 6. The historical data 706 may include past vehicle operation data, environmental data, or driver behavior data. In some implementations, the historical data 706 may be continually updated as the vehicle operates, allowing for more accurate comparisons and trend analysis over time. In some implementations, the historical data 706 may include aggregated data from multiple vehicles, allowing for more robust pattern recognition and anomaly detection.

At 704, the process includes determining a difference between the current data and historical data. This step may be performed by a difference component such as, for example, the difference component 620 shown in FIG. 6. In some implementations, the difference determination may involve statistical analysis or machine learning algorithms to identify subtle patterns or trends in the data. The difference may be quantified as a difference vector including one or more values.

The difference component may employ various techniques to determine the difference vector between current data and historical data. In some implementations, the difference component may utilize simple statistical methods to calculate the difference. For example, the difference component may compute the mean and standard deviation of historical data for each parameter, then compare current values to determine if they fall outside a predefined range. For example, if the average historical speed on a particular road segment is 60 mph with a standard deviation of 5 mph, a current speed of 75 mph may be flagged as a significant difference and incorporated into the difference vector.

In other implementations, the difference component may leverage machine learning algorithms to identify anomalies and patterns. For instance, the system may employ anomaly detection models trained on historical data to recognize unusual patterns or deviations in the current data. A neural network may be trained to recognize typical acceleration patterns for specific drivers on various road types. If the current acceleration data shows an unusual pattern, such as frequent rapid accelerations and decelerations in a highway environment, the model may flag this as a significant difference and include it in the difference vector.

The difference component may incorporate time-series analysis techniques to account for temporal patterns and trends in the data. In some cases, the difference component may use methods like STL or ARIMA models to separate long-term trends, seasonal patterns, and short-term fluctuations in the historical data. This approach may allow the system to identify differences that are significant within the context of time-varying patterns. For example, the system may recognize that while current traffic congestion is higher than the historical average for a given road segment, it is within normal ranges for that time of day and day of the week, and adjust the difference vector accordingly.

In some implementations, the difference component may generate a multidimensional difference vector that captures changes across multiple parameters simultaneously. This vector may include normalized difference scores for various aspects of vehicle operation and environmental conditions, allowing for a more comprehensive representation of the current state relative to historical norms. The component may use techniques like PCA or t-SNE to reduce the dimensionality of this vector while preserving important relationships between parameters. This condensed representation may then be used by other components of the system to generate appropriate visual feedback that reflects the most significant changes in the vehicle's operating context.

At 708, a scalar may be created based on the determined difference. In some implementations, this scalar may represent a normalized measure of how much the current operating conditions deviate from historical norms. The scalar may be used to determine the intensity or prominence of visual changes in the dynamic image content. In other implementations, instead of a scalar, a multidimensional vector may be created to capture changes across multiple parameters simultaneously.

At 710, the system evaluates whether cached images are available. This step may involve checking an image store similar to the image store 610 shown in FIG. 6. In some implementations, the image store may be a local database within the vehicle, while in other implementations, it may be a cloud-based repository that can be accessed over a network connection. The use of cached images can help reduce processing time and system load, especially for frequently used visual elements.

If cached images are available (Yes branch), at 712 cached images are obtained from an image store. In some implementations, these cached images may be pre-rendered visual elements or templates that can be quickly modified based on the current data and calculated difference. The cached images may include various visual representations of vehicle states, environmental conditions, or abstract design elements that can be combined to create the final dynamic image content.

If cached images are not available (No branch), at 718, the scalar may be provided to transformation model to augment image output. In some implementations, the transformation model may be a machine learning model, such as a generative adversarial network (GAN) or a style transfer network, capable of creating or modifying images based on input parameters. The scalar (or vector) created in step 708 may be used to guide the transformation process, determining the extent and nature of the visual changes applied to base images or generated from scratch. In some implementations, the transformation model may be included in an image data generator such as, for example, the image data generator 622 show in FIG. 6.

At 720, transformation output is saved to the image store. This step allows newly generated or modified images to be cached for future use, potentially improving system performance over time. In some implementations, the image store may employ intelligent caching strategies, keeping frequently used or recently generated images readily available while archiving or discarding less relevant content.

From either step 712 or step 718, the process 700 continues to step 714, where dynamic image data is generated. This step may be performed by an image data generator similar to the image data generator 622 shown in FIG. 6. In some implementations, this step may involve compositing multiple visual elements, applying real-time effects or animations, or generating entirely new visual content based on the current data and calculated difference. The dynamic image data may be optimized for the specific display device or devices used in the vehicle, taking into account factors such as screen resolution, color gamut, or refresh rate. Generating the dynamic image data may be based on the scalar, the difference vector, and/or visualization style data 716.

In some implementations, the visualization style data may be determined by a visualization style component such as, for example, the visualization style component 618 shown in FIG. 6. The visualization style may define the overall aesthetic and functional approach to presenting information visually, such as color schemes, animation styles, or layout preferences, among other examples. In some implementations, the visualization style may be customizable based on driver preferences or may adapt automatically based on factors such as time of day, driving conditions, or detected driver state, among other examples.

In some implementations, the dynamic image data may be generated by determining a visualization style based on at least one of a set of configured visualization styles or an operating context of the vehicle. This process may further include determining, using a transformation model, a set of image parameter values based on at least one of a difference vector or current data. The dynamic image data may then be generated based on the selected visualization style and the determined image parameter values.

The transformation model may be configured to determine image parameter values based on the difference vector or current data. In some implementations, the transformation model may be a machine learning model, such as a neural network, trained on a diverse dataset that includes various vehicle operating conditions and corresponding visual representations. The model may analyze input data to identify patterns and features relevant to visual elements.

When determining image parameter values, the transformation model may receive as input the difference vector or specific portions of the current data. The model may process this input through multiple layers, extracting features and patterns to derive parameters that define visual modifications or generation. These parameters may include color values, opacity levels, scale factors, animation parameters, texture coordinates, and geometry deformation values. For example, the model may output RGB or HSL color values to adjust the display's color scheme based on the current operating context or determine transparency levels for overlay elements to emphasize specific information. Similarly, the model may provide parameters for resizing, repositioning, or animating visual elements to enhance their relevance or usability.

In some implementations, the transformation model may utilize attention mechanisms to focus on the most critical aspects of the input data. This may allow the model to prioritize modifications that align with the current operating context, ensuring the most significant elements are emphasized. Additionally, the model may incorporate temporal dynamics, employing recurrent neural network architectures to account for changes over time. This temporal awareness may help produce smooth transitions between visual states, resulting in a more fluid and intuitive visual experience for the driver.

The transformation model may also employ a hierarchical architecture, with specialized sub-models focusing on distinct aspects of visualization. For instance, one sub-model may handle color transformations, while another may manage geometric deformations. The outputs from these sub-models may be combined to generate the final set of image parameter values, ensuring a comprehensive approach to visual representation.

In some implementations, the transformation model may be continually fine-tuned based on feedback from driver interactions and system performance metrics. This feedback loop may enable the model to adapt to individual driver preferences and improve its predictive accuracy over time. Such adaptive learning capabilities may enhance the overall effectiveness of the dynamic image generation system by aligning its output with user-specific needs and operational requirements.

In some implementations, the process 700 may include additional steps or decision points not shown in FIG. 7. For example, there may be a step to prioritize different types of information based on their importance or urgency, ensuring that important alerts are always prominently displayed. Additionally, there may be steps to integrate the dynamic image content with other vehicle systems, such as audio feedback or haptic alerts, to create a cohesive and multi-modal information delivery system.

The process 700 may also include error handling and fallback mechanisms not explicitly shown in FIG. 7. For example, if there are issues with sensor data or image generation, the system may revert to a simplified or static display mode to ensure that essential information is still conveyed to the driver. In some implementations, the process may include self-diagnostic steps to monitor its own performance and adjust parameters to optimize responsiveness and visual quality.

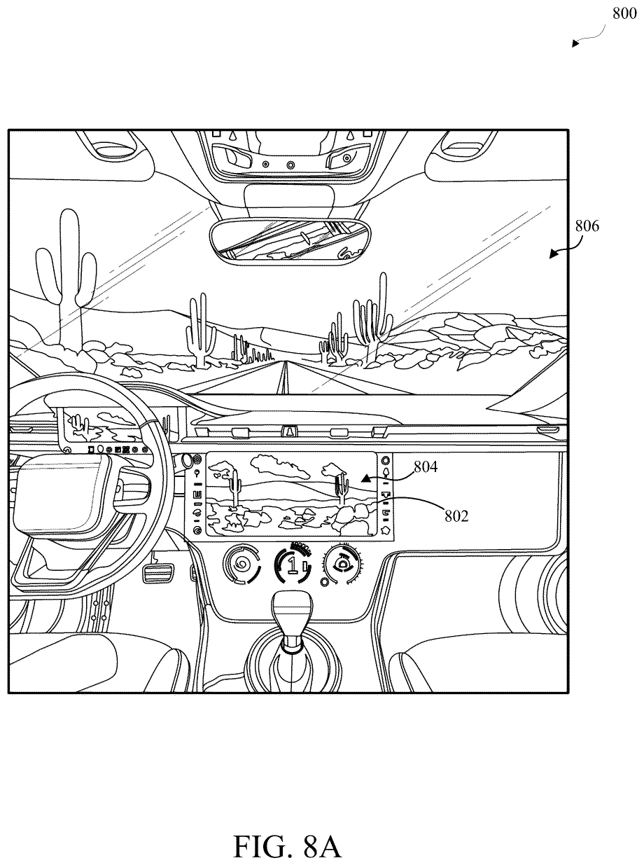

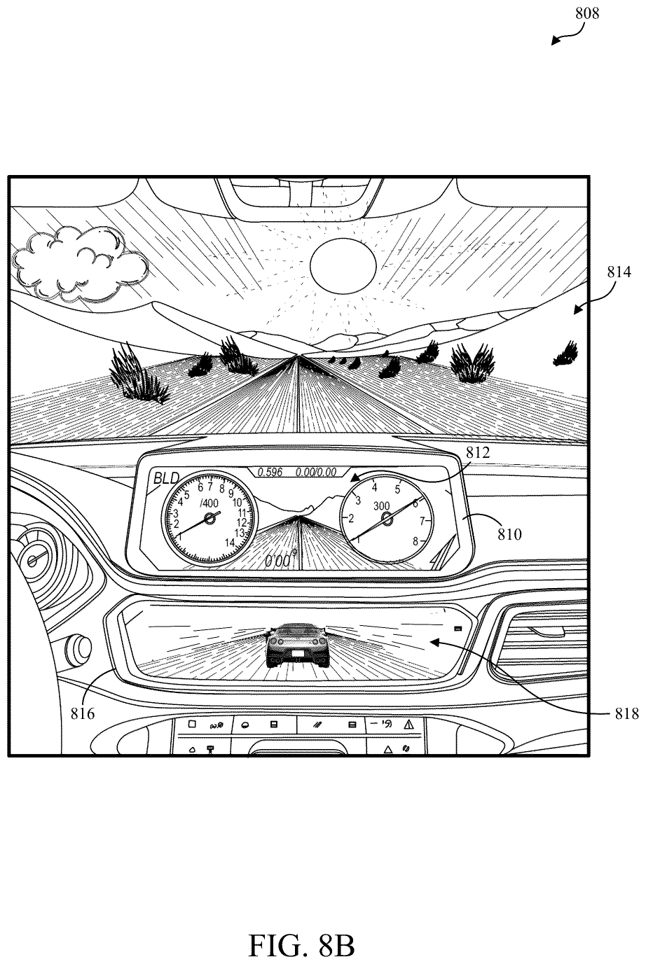

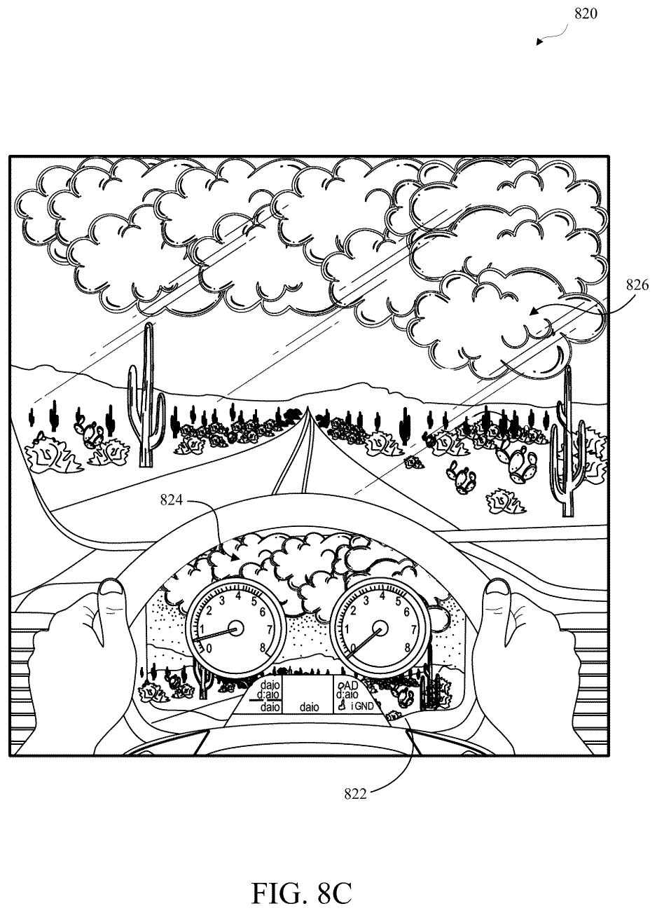

FIGS. 8A-8C are diagrams illustrating examples associated with dynamic image generation, in accordance with implementations of the present disclosure.

FIG. 8A illustrates an example 800 showing an interior view of a vehicle cockpit with a dynamic display system. In some implementations, the example 800 may include a display device 802 integrated into the vehicle's dashboard. The display device 802 may be configured to present dynamic image content 804 corresponding to the external environment 806 visible through the windshield. In some implementations, the display device 802 may comprise at least one of a windshield of the vehicle, an HUD device of the vehicle, an instrument cluster of the vehicle, or an infotainment system of the vehicle.

The external environment 806 depicted in FIG. 8A shows a desert landscape with cactus plants and a road extending into the distance. In some implementations, the dynamic image generation system may obtain current data related to this environment outside of the vehicle using one or more sensors. These sensors may include at least one of a camera device, a LiDAR device, or a weather monitoring device.

The display device 802 shows visual elements that reflect and respond to the surrounding environment, with the dynamic image content 804 incorporating stylized representations of the desert scene. This visualization demonstrates how the dynamic image generation system may generate dynamic image data based on a visualization style and the difference between current and historical data. The dynamic image content 804 may be generated to provide an intuitive and engaging visual representation of the vehicle's status and surroundings, particularly in electric vehicles where traditional auditory and vibrational cues may be absent.

In some implementations, the dynamic image content 804 may be generated based on various sources of visual information. The system may utilize cached images of desert landscapes stored in the image store, allowing for quick rendering of familiar environments. In some implementations, the dynamic image content 804 may be created using real-time data from the vehicle's external sensors, such as cameras or LIDAR systems, to capture and stylize the current external environment 806. In some implementations, the system may combine both cached and current image data, overlaying real-time elements onto pre-rendered backgrounds. The choice between using cached images, current sensor data, or a combination may depend on factors such as processing power availability, network connectivity, and the specific visualization requirements of the current driving context. This flexible approach allows the system to maintain visual fidelity and responsiveness across various operating conditions.

In some implementations, the dynamic image generation system may employ image fusion techniques to create more comprehensive and informative dynamic image content. Image fusion may involve combining data from multiple sensors or image sources to produce a single, enhanced visualization that incorporates the strengths of each input. For example, the system may fuse high-resolution camera imagery with depth information from LIDAR sensors to create a more detailed and spatially accurate representation of the external environment. This fused image may then be stylized or transformed to match the current visualization style while maintaining important spatial relationships and object recognition capabilities.

The image fusion process may be used to blend real-time sensor data with pre-rendered or cached image elements. For instance, in a urban driving scenario, the system may fuse live traffic camera feeds with pre-existing 3D models of buildings and landmarks. This approach may allow for a dynamic representation of current traffic conditions within a familiar and consistently rendered cityscape. In some implementations, the system may incorporate data from V2V or V2I communications into the fused image, visualizing the positions and intentions of nearby vehicles or the status of upcoming traffic signals. By fusing these diverse data sources, the dynamic image content may provide drivers with a rich, context-aware visualization that enhances situational awareness and decision-making capabilities.

In some implementations, the dynamic image content 804 may be generated based on current data comprising at least one of a speed of the vehicle, an acceleration of the vehicle, a weather condition, or an interaction between the vehicle and the road. For example, the system may incorporate real-time data about the road conditions in the desert environment to adjust the visual representation accordingly.

FIG. 8B illustrates an example 808 showing an orthogonal view of a vehicle interior display configuration. In some implementations, the example 808 may include a display device 810 that displays dynamic image content 812 in the form of environmental context, gauges and visual indicators. The external environment 814 is shown through the windshield, featuring a road with vegetation and sky elements. In some implementations, a second display device 816 may be positioned below the first, showing additional dynamic image content 818 that includes a vehicle visualization and control interface elements. The dynamic image content 812 and 818 may be integrated into the vehicle's dashboard layout to present information to the driver in an intuitive and easily digestible format. In some implementations, the dynamic image content 812 and 818 may be integrated and displayed on a single display device or across more than two display devices.

As shown in example 808, the additional dynamic image content 818 may reflect an increased speed of the vehicle through various visual cues and transformations. As the vehicle's speed increases, the system may adjust the dynamic image content to convey this change to the driver in an intuitive and engaging manner. For example, the system may modify the perspective of the displayed environment, creating a sense of increased depth and forward motion. This may involve elongating road markings, stretching landscape elements, or increasing the rate at which objects in the periphery appear to move past the vehicle. The system may adjust the level of detail in distant objects, simulating the effect of objects becoming less distinct at higher speeds.

In some cases, the dynamic image content may incorporate motion blur effects, particularly for elements at the edges of the display. This blur effect may become more pronounced as the vehicle's speed increases, mimicking the visual experience of looking out a side window at higher velocities. The system may modify the color palette of the dynamic image content to reflect higher speeds. For instance, cooler colors like blues and greens may shift towards warmer tones such as oranges and reds, subtly conveying a sense of increased energy and velocity.

In implementations where the dynamic image content includes gauge-like elements, these may be updated in real-time to reflect the current speed. Digital speedometers may change color, size, or position based on speed thresholds, while analog-style gauges may incorporate dynamic elements such as glowing effects or animated needles that become more prominent at higher speeds.

The system may also adjust the rate of animation for any moving elements within the dynamic image content. For example, clouds in a sky visualization may move faster across the display, or the frequency of passing landscape elements may increase, correlating with the vehicle's speed. In some implementations, the dynamic image content may incorporate additional visual elements that appear or become more prominent at higher speeds. These could include wind or air flow visualizations, dynamic force lines, or abstract patterns that convey a sense of rapid movement.

The system may adjust the overall layout and composition of the dynamic image content as speed increases. This could involve streamlining the display by reducing non-essential information, enlarging speed-related data, or shifting the visual focus towards the center of the display to mimic the driver's natural tendency to focus straight ahead at higher velocities.

The multiple display configuration shown in FIG. 8B demonstrates how the dynamic image generation system may be implemented across various display devices within the vehicle. In some implementations, each display device may be tailored to present specific types of information or visual feedback. For example, the upper display device 810 may focus on driving information, while the lower display device 816 may provide supplementary data or interactive controls.

FIG. 8C illustrates an example 820 showing a driver's view of an instrument cluster display device 822 and the external environment 826 visible through the windshield. In some implementations, the instrument cluster display device 822 may display dynamic image content 824 that incorporates visual elements reflecting the external environment 826. This implementation demonstrates how the dynamic image generation system can create a cohesive visual experience that bridges the gap between the vehicle's interior displays and the surrounding environment.

The external environment 826 includes a desert landscape with cactus plants, clouds in the sky, and a winding road. In some implementations, the dynamic image content 824 shown on the instrument cluster display device 822 may include two circular gauge displays with numerical indicators, where decorative cloud-like visual elements are integrated around the gauges in a style that complements the actual clouds visible in the external environment 826. The system may analyze the current environmental conditions and compare them to historical data to generate appropriate visual representations. For example, the cloud-like elements in the display may be dynamically generated based on the current weather conditions detected by the vehicle's sensors.

In some implementations, the visualization style used to generate the dynamic image content 824 may be determined based on at least one of a set of configured visualization styles or an operating context of the vehicle. For instance, the desert environment may trigger a specific visualization style that emphasizes warm colors and organic shapes to match the landscape. The dynamic image content 824 displayed on the instrument cluster display device 822 demonstrates how the system can provide vehicle information while maintaining visual harmony with the surrounding landscape. This approach may help reduce cognitive load on the driver by presenting information in a context-aware and visually intuitive manner.

In some implementations, the dynamic image generation system described herein may incorporate biometric data from the driver as an input to further personalize the visual content. For example, the system may use heart rate monitors integrated into the steering wheel or seat to detect the driver's stress levels. Based on this input, the system may adjust the color scheme and complexity of the displayed information. For example, the system may use cooler colors and simpler layouts when stress levels are high to promote a calming effect.

In some implementations, the dynamic image generation system described herein may utilize eye-tracking technology to monitor the driver's gaze patterns and adjust the display content accordingly. For instance, if the eye-tracking system detects that the driver frequently glances at the fuel gauge, the system may enlarge or highlight this information, making it more prominent within the dynamic image content. This adaptive approach may help ensure that the most relevant information for each individual driver is easily accessible.

In some implementations, the dynamic image generation system described herein may integrate data from the vehicle's suspension and steering systems to provide visual feedback about road conditions. The system may analyze inputs such as wheel position sensors and shock absorber compression rates to create real-time visualizations of the road surface. This may be particularly useful in off-road scenarios, where the system could generate a stylized representation of upcoming terrain features, helping the driver navigate challenging environments more effectively.

In some implementations, the dynamic image generation system described herein may incorporate weather forecast data in addition to current sensor readings to provide predictive visual elements in the dynamic image content. For example, if the weather forecast indicates an approaching storm system, the display may gradually introduce storm cloud elements or subtle lightning effects in the background of the instrument cluster, even before the weather change is visible through the windshield. This may help prepare the driver for upcoming changes in driving conditions.

In some implementations, the dynamic image generation system may use data from the vehicle's navigation system to adapt the visual content based on the planned route. For instance, if the navigation system indicates an upcoming steep incline, the display may adjust to emphasize powertrain information such as engine temperature or battery charge levels for electric vehicles. Similarly, when approaching a complex intersection or roundabout, the system may transition to a more detailed top-down view of the immediate surroundings to assist with navigation.

In some implementations, the dynamic image generation system described herein may incorporate data from the vehicle's ADAS to enhance the dynamic image content. For example, when adaptive cruise control is engaged, the display may show a stylized representation of the distance to the vehicle ahead, dynamically updating this visualization as the gap changes. If lane-keeping assist detects an unintentional lane departure, the system may generate subtle visual cues along the edges of the display to guide the driver back to the center of the lane.

In some implementations, the dynamic image generation system described herein may use data from the vehicle's infotainment system to integrate relevant information into the display. For instance, if a music track is playing, the system may incorporate subtle visual elements that pulse or change in time with the music's rhythm, creating a more immersive driving experience without being distracting. Similarly, when receiving a phone call through the vehicle's Bluetooth system, the display may temporarily adjust to prominently show caller information while maintaining essential driving data.

In some implementations, the dynamic image generation system described herein may also utilize historical driving data to anticipate and prepare for recurring scenarios. For example, if the system detects that the vehicle is approaching a location where the driver typically experiences heavy traffic during certain times of day, it may proactively adjust the display to emphasize traffic flow information and alternate route suggestions. This predictive approach may help drivers make informed decisions before encountering potential delays or obstacles.

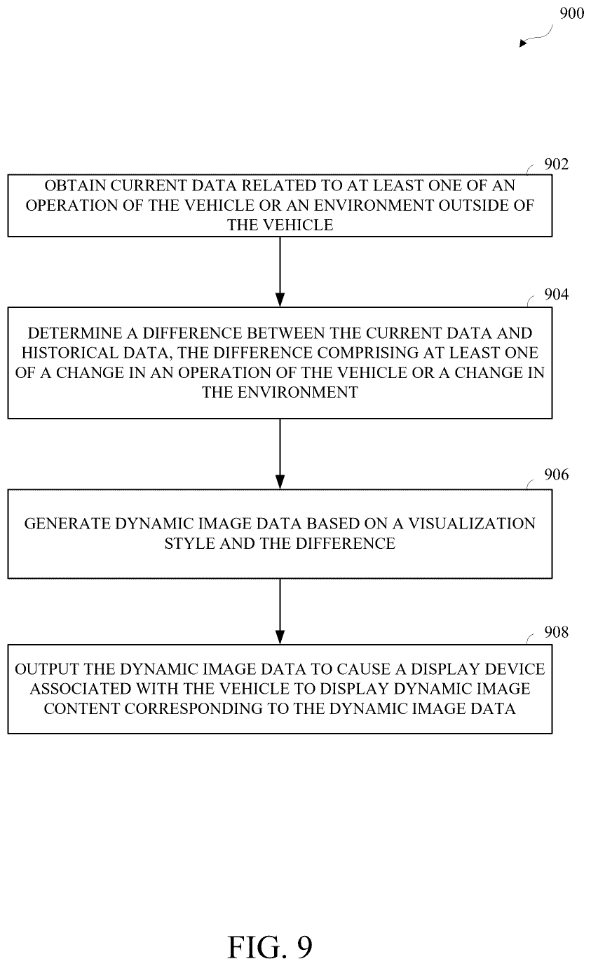

To further describe some implementations in greater detail, reference is next made to examples of techniques which may be performed by or using the dynamic image generation system as described herein. FIG. 9 is a flowchart of an example of a technique associated with dynamic image generation for vehicle displays. The technique 900 can be executed using computing devices, such as the systems, hardware, and software described with respect to FIGS. 1-8. The technique 900 can be performed, for example, by executing a machine-readable program or other computer-executable instructions, such as routines, instructions, programs, or other code. The steps, or operations, of the technique 900, or another technique, method, process, or algorithm described in connection with the implementations disclosed herein can be implemented directly in hardware, firmware, software executed by hardware, circuitry, or a combination thereof.

For simplicity of explanation, the technique 900 is depicted and described herein as a series of steps or operations. However, the steps or operations of the technique 900 can occur in various orders and/or concurrently. Additionally, other steps or operations not presented and described herein may be used. Furthermore, not all illustrated steps or operations may be required to implement a technique in accordance with the disclosed subject matter.

At 902, the technique 900 includes obtaining current data related to at least one of an operation of the vehicle or an environment outside of the vehicle. For example, a sensor system (e.g., the sensors 604 shown in FIG. 6) may obtain current data such as vehicle speed, acceleration, weather conditions, or road surface conditions. In some implementations, the current data may be obtained from various types of sensors, including radar devices, LiDAR devices, camera devices, proximity sensors, vehicle control devices, weather monitoring devices, motion sensors, IMUs, or geo-location devices. Additionally, in some implementations, the current data may include information from V2V or V2I communication systems, providing a broader context for the vehicle's current operating environment.

At 904, the technique 900 includes determining a difference between the current data and historical data, the difference comprising at least one of a change in an operation of the vehicle or a change in the environment. In some implementations, a difference component (e.g., the difference component 620 shown in FIG. 6) may perform this step by comparing the current data to historical data stored in a data store. The historical data may include past vehicle operation data, environmental data, or driver behavior data. In some implementations, the historical data may be continuously updated as the vehicle operates, allowing for more accurate comparisons and trend analysis over time. Additionally, in some implementations, the historical data may include aggregated data from multiple vehicles, allowing for more robust pattern recognition and anomaly detection.

At 906, the technique 900 includes generating dynamic image data based on a visualization style and the difference. For example, an image data generator (e.g., the image data generator 622 illustrated in FIG. 6) may create visual content that reflects the current vehicle status and environmental conditions. In some implementations, this step may involve determining a visualization style based on at least one of a set of configured visualization styles or an operating context of the vehicle. The visualization style may define the overall aesthetic and functional approach to presenting information visually, such as color schemes, animation styles, or layout preferences. In some implementations, the visualization style may be customizable based on driver preferences or may adapt automatically based on factors such as time of day, driving conditions, or detected driver state.

At 908, the technique 900 includes outputting the dynamic image data to cause a display device associated with the vehicle to display dynamic image content corresponding to the dynamic image data. In some implementations, an in-vehicle infotainment system (e.g., the in-vehicle infotainment system 606 shown in FIG. 6) may present the dynamic image content on one or more display devices within the vehicle. The display device may comprise at least one of a windshield of the vehicle, an HUD device of the vehicle, an instrument cluster of the vehicle, an infotainment system of the vehicle, or an electronic device of a user of the vehicle. In some implementations, the dynamic image content may be displayed across multiple display devices, each tailored to present specific types of information or visual feedback.

In some implementations, the technique 900 may include additional steps not explicitly shown in FIG. 9. For example, the technique may include identifying a driver associated with the vehicle and obtaining profile data associated with the driver. This may involve obtaining a driver image and comparing it to one or more profile images associated with the driver, or obtaining a driver biological characteristic from an internal sensing device and determining the profile data based on the driver biological characteristic. The visualization style may then be determined based on this profile data, allowing for a personalized visual experience.

In some implementations, the technique 900 may also include obtaining media content associated with a media platform and incorporating this content into the generated dynamic image content. The media content may comprise at least one of video content, audio content, image content, text content, or advertising content. This feature may allow for the integration of external information sources into the vehicle's display system, providing a more comprehensive and engaging visual experience for the vehicle occupants.

The technique 900 may also include steps for error handling and fallback mechanisms. For example, if there are issues with sensor data or image generation, the system may revert to a simplified or static display mode to ensure that essential information is still conveyed to the driver. In some implementations, the technique may include self-diagnostic steps to monitor its own performance and adjust parameters to optimize responsiveness and visual quality.

In some implementations, the technique 900 may be extended to work in conjunction with other vehicle systems. For example, the dynamic image generation system may integrate with ADAS or autonomous driving features, adapting the visual content to support different levels of vehicle autonomy. The system may also coordinate with audio feedback or haptic alert systems to create a cohesive and multi-modal information delivery system.

Furthermore, in some implementations, the technique 900 may include steps for continuous learning and adaptation. The system may employ machine learning algorithms to refine its visualization styles and content generation based on driver interactions and preferences over time. This could involve analyzing patterns in driver behavior, environmental conditions, and vehicle performance to proactively generate more relevant and effective visual content.

The foregoing disclosure provides illustration and description but is not intended to be exhaustive or to limit the aspects to the precise forms disclosed. Modifications and variations may be made in light of the above disclosure or may be acquired from practice of the aspects. As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, the terminology “instructions” may include directions or expressions for performing any technique, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, techniques, or combinations thereof, as described herein. Instructions, or a portion thereof, may be implemented as a special purpose processor, or circuitry, that may include specialized hardware for carrying out any of the techniques, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the terminology “or” is intended to mean an inclusive “or” rather than an exclusive “or” and may be used interchangeably with “and/or,” unless explicitly stated otherwise (for example, if used in combination with “either” or “only one of”), or clearly is used otherwise from context. In addition, the articles “a” and “an” as used in this application and the appended claims should generally be construed to mean “one or more” unless specified otherwise or clear from context to be directed to a singular form. Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Accordingly, unless explicitly stated otherwise, the phrase “based on” is intended to mean “based at least in part on.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. Further, for simplicity of explanation, although the figures and descriptions herein may include sequences or series of steps or stages, elements of the techniques disclosed herein may occur in various orders or concurrently. Additionally, elements of the techniques disclosed herein may occur with other elements not explicitly presented and described herein. Furthermore, not all elements of the techniques described herein may be required to implement a technique in accordance with this disclosure. Although aspects, features, and elements are described herein in particular combinations, each aspect, feature, or element may be used independently or in various combinations with or without other aspects, features, and elements.

The above-described aspects, examples, and implementations have been described in order to allow easy understanding of the disclosure are not limiting. On the contrary, the disclosure covers various modifications and equivalent arrangements included within the scope of the appended claims, which scope is to be accorded the broadest interpretation so as to encompass all such modifications and equivalent structure as is permitted under the law.

What is claimed is:

1. A dynamic image generation system for a vehicle display, comprising:
one or more sensors configured to obtain current data related to at least one of an operation of a vehicle or an environment outside of the vehicle;
a display device;
a memory having instructions stored therein; and
processing circuitry communicatively coupled to the one or more sensors, the display device, and the memory, wherein the processing circuitry is configured to execute the instructions to cause the dynamic image generation system to:
determine a difference between the current data and historical data, the difference comprising at least one of a change in an operation of the vehicle or a change in an interaction between the vehicle and the environment;
generate dynamic image data based on a visualization style and the difference; and
output the dynamic image data to cause the display device to display dynamic image content corresponding to the dynamic image data.

2. The dynamic image generation system of claim 1, wherein the current data comprises at least one of a speed of the vehicle, an acceleration of the vehicle, a weather condition, or an interaction between the vehicle and a road.

3. The dynamic image generation system of claim 1, wherein the one or more sensors comprise at least one of a radar device, a light detection and ranging (LIDAR) device, a camera device, a proximity sensor, a vehicle control device that controls an aspect of the operation of the vehicle, a weather monitoring device, a motion sensor, an inertial measurement unit (IMU), or a geo-location device.

4. The dynamic image generation system of claim 1, wherein the display device comprises at least one of a windshield of the vehicle, a head up display (HUD) device of the vehicle, an instrument cluster of the vehicle, an infotainment system of the vehicle, or an electronic device of a user of the vehicle.

5. The dynamic image generation system of claim 1, wherein, to determine the difference between the current data and the historical data, the processing circuitry is configured to execute the instructions to cause the dynamic image generation system to:
determine a first parameter value based on the current data;
determine a second parameter value based on the historical data; and
determine a difference between the first parameter value and the second parameter value.

6. The dynamic image generation system of claim 1, wherein, to generate the dynamic image data based on the visualization style and the difference, the processing circuitry is configured to execute the instructions to cause the dynamic image generation system to:
determine a visualization style based on at least one of a set of configured visualization styles or an operating context of the vehicle;
obtain, based on the difference and from an image store, an image corresponding to the visualization style; and
generate the dynamic image data based on the visualization style and the image.

7. The dynamic image generation system of claim 1, wherein, to generate the dynamic image data based on the visualization style and the difference, the processing circuitry is configured to execute the instructions to cause the dynamic image generation system to:
determine a visualization style based on at least one of a set of configured visualization styles or an operating context of the vehicle;
determine, using a transformation model, a set of image parameter values based on at least one of the difference or the current data; and
generate the dynamic image data based on the visualization style and the set of image parameter values.

8. The dynamic image generation system of claim 1, wherein the processing circuitry is configured to execute the instructions to cause the dynamic image generation system to:
obtain an indication of a user input via an input device; and
determine the visualization style based on the indication of the user input.

9. The dynamic image generation system of claim 1, wherein the difference comprises an indication of a change in a driving behavior of a driver of the vehicle.

10. A method for generating dynamic image content for a display system of a vehicle, comprising:
obtaining current data related to at least one of an operation of the vehicle or an environment outside of the vehicle;
determining a difference between the current data and historical data, the difference comprising at least one of a change in an operation of the vehicle or a change in the environment;
generating dynamic image data based on a visualization style and the difference; and
outputting the dynamic image data to cause a display device associated with the vehicle to display dynamic image content corresponding to the dynamic image data.

11. The method of claim 10, wherein the current data comprises at least one of a speed of the vehicle, an acceleration of the vehicle, a weather condition, or an interaction between the vehicle and a road.

12. The method of claim 10, further comprising:
identifying a driver associated with the vehicle;
obtaining profile data associated with the driver; and
determining the visualization style based on the profile data.

13. The method of claim 12, wherein identifying the driver associated with the vehicle comprises:
obtaining a driver image associated with the driver; and
comparing the driver image to one or more profile images associated with the driver.

14. The method of claim 12, wherein obtaining profile data associated with the driver comprises:
obtaining, from an internal sensing device, a driver biological characteristic; and
determining the profile data based on the driver biological characteristic.

15. The method of claim 10, wherein obtaining the current data comprises receiving the current data from the vehicle.

16. The method of claim 10, wherein determining the difference between the current data and the historical data comprises determining, by a computing device external to the vehicle, the difference based on the current data and the historical data.

17. A non-transitory computer-readable storage medium storing a set of instructions that, when executed by processing circuitry of a device, cause the device to perform operations comprising:
obtaining current data related to at least one of an operation of a vehicle or an environment outside of the vehicle;
determining a difference between the current data and historical data, the difference comprising at least one of a change in an operation of the vehicle or a change in the environment;
generating dynamic image data based on a visualization style and the difference; and
outputting the dynamic image data to cause a display device associated with the vehicle to display dynamic image content corresponding to the dynamic image data.

18. The non-transitory computer-readable storage medium of claim 17, wherein the current data comprises at least one of a speed of the vehicle, an acceleration of the vehicle, a weather condition, or an interaction between the vehicle and a road.

19. The non-transitory computer-readable storage medium of claim 17, wherein the operations further comprise:
obtaining media content associated with a media platform; and
generating the dynamic image content based on the media content.

20. The non-transitory computer-readable storage medium of claim 19, wherein the media content comprises at least one of video content, audio content, image content, text content, or advertising content.
